(19) United States
(12) Patent Application Publication
(10) Pub. No.: US 2024/0311526 A1
(43) Pub. Date: Sep. 19, 2024

(54) METHOD FOR ESTIMATING REACTIVE ION FLUX AND POTENTIAL IN LITHIUM ION BATTERY

(71) Applicant: TSINGHUA UNIVERSITY, Beijing (CN)

(72) Inventors: Qixin CHEN, Beijing (CN); Yuxuan GU, Beijing (CN); Hongye GUO, Beijing (CN); Kedi ZHENG, Beijing (CN); Chongqing KANG, Beijing (CN); Qing XIA, Beijing (CN); Yuanbo CHEN, Beijing (CN)

(21) Appl. No.: 18/573,841

(22) PCT Filed: Jun. 22, 2022
(86) PCT No.: PCT/CN2022/100570

§ 371 Date: Dec. 22, 2023

(30) Foreign Application Priority Data
Jun. 29, 2021 (CN) 202110725759.6

(51) Int. Cl. G06F 30/20; G06F 119/08; H01M 10/0525

(52) U.S. Cl. CPC G06F 30/20; H01M 10/0525; G06F 2119/08

(57) ABSTRACT

A method for estimating a reactive ion flux and a potential inside a lithium-ion battery includes: obtaining states and parameters of a battery port and points to be analyzed inside the battery required for calculation; calculating reaction parameters of the points to be analyzed inside the battery; calculating a spatial distribution function of a reactive ion flux inside the battery; and calculating a spatial distribution function of a potential of an electrolyte inside the battery.

### CROSS-REFERENCE TO RELATED APPLICATION

This application is a national stage entry under 35 U.S.C. § 371 of International Application PCT/CN2022/100570, filed Jun. 22, 2022, which claims priority to Chinese Patent Application No. 202110725759.6, filed w on Jun. 29, 2021, the entire disclosures of which are incorporated herein by reference.

### FIELD

The present disclosure is a method for estimating a reactive ion flux and a potential inside a lithium-ion battery, and relates to a related technology in a field of modeling and simulation of the lithium-ion battery.

### BACKGROUND

Lithium-ion batteries are widely used in an energy industry, a transportation industry, an information technology industry and other fields. Improving an economy and a safety of a battery use is of great significance to a development of human society. At this stage, an analysis of lithium-ion batteries is mostly based on a simple battery equivalent circuit model in practical applications, which can only describe external characteristics of the batteries, but cannot reflect internal conditions of the batteries. However, the equivalent circuit model is still adopted by current mainstream battery management systems. This is due to a limited computing power of terminals in various application scenarios, and it is difficult to support a deployment of electrochemical models of the lithium-ion batteries with a high precision. However, with an increasing demand for high-precision modeling of the batteries, it is urgent to propose a practical modeling method for an electrochemical mechanism of the lithium-ion batteries, so that the models have both abilities to describe internal characteristics and the external characteristics of the batteries without a significantly increase in complexity, and then serve various battery management system applications, such as a health monitoring, an operating domain estimation, a remaining power estimation, etc.

The key to a complexity of an electrochemical model of a lithium-ion battery is that it is a set of partial differential equations based on a time dimension and a plurality of spatial dimensions, and often requires a large number of iterations to obtain numerical solutions of related variables. At present, two main ideas are provided for simplification of the electrochemical model of the lithium-ion battery: a first one is to find an equation with similar transfer function characteristics to an original partial differential equation set through a frequency domain analysis method, and then map it back to a time domain; a second one is to find an analytical expression or an empirical formula of an internal state quantity of the battery through various simplifications and approximations. A single-particle electrochemical model, which is widely used at present, is a representative of the second simplification idea. However, the existing technology only simplifies a radial diffusion process of lithium ions in active particles, but ignores an impact of the lithium ions upon migrating along a thickness direction of the battery on an inhomogeneous chemical reaction inside the battery. Therefore, it is of great significance to model a spatial distribution of key state quantities inside the lithium-ion battery in the thickness direction of the battery. A reactive ion flux and a potential of an electrolyte are most important for analyzing the internal characteristics and the external characteristics of the battery, and main electrochemical processes occurring inside the battery are basically grasped by mastering a spatial distribution rule of these two variables. By establishing a simplified analytical model of a spatial distribution of the reactive ion flux and the potential of the electrolyte inside the lithium-ion battery, it is possible to implement a lithium-ion battery modeling with a low computational complexity, and promote applications of the electrochemical model in various scenarios. Background technology related to the present disclosure includes as follows.

(1) A measurement of an electrode equilibrium potential function: the electrode equilibrium potential function U_{OCP}=ƒ(x;T) reflects thermodynamic characteristics of a deintercalation chemical reaction of a lithium ion on an electrode surface, also known as an equilibrium potential of an electrode. A measurement method thereof is as follows: a pole piece is prepared from an electrode material, assembled with a metal lithium piece into a button half-battery, then cycled with a small current for charging and discharging, and an overall U_{OCP}=ƒ(x;T) curve can be obtained by measuring open circuit voltages of the electrode material in different states of charge (x∈[0, 1]) and different temperatures. For details on a measurement method of the electrode equilibrium potential function, reference is made to Lei, H. and Han, Y. Y. The measurement and analysis for Open Circuit Voltage of Lithium-ion Battery[J]. In Journal of Physics: Conference Series (Vol. 1325, No. 1, p. 012173). IOP Publishing.

(2) Geometric modeling methods for cylindrical batteries, square batteries, and pouch batteries: when analyzing an actual battery, it is first necessary to establish a plane two-dimensional model of the battery according to geometric dimensions of the battery, and then obtain parameters, such as Lₙ, Lₛₑₚ, Lₚ, Aₙ, Aₚ, and Aₛₑₚ, and a coordinate x of a point to be analyzed. For details on the geometric modeling method of the battery, reference is made to Kalupson, J., Luo, G., and Shaffer, C., “AutoLion™: A Thermally Coupled Simulation Tool for Automotive Li-Ion Batteries,” SAE Technical Paper 2013-01-1522, 2013.

(3) A parameter identification technology: the parameter identification technology is to determine parameter values of a set of models according to experimental data and established models, so that numerical results obtained by a model calculation can best fit test data. In this method, electrode parameters R_{s,p/n}, εₛ, εₑ, and R_{ƒ} are determined by the electrode material and a battery manufacturing process. For some new batteries, these parameters are unknown, and can be obtained through data obtained from an electrode test by using the parameter identification technology.

(4) A method of a large condition number matrix inversion: a balance method is used to reduce a condition number of a coefficient matrix, so that an original ill-conditioned linear equation is equivalent to a non-ill-conditioned easy-to-solvable equation. According to a principle of balance, for ill-conditioned linear equations Ax=b, largest row elements in A are extracted to form a diagonal matrix as a non-singular matrix M, and both ends of Ax=b are multiplied by M⁻¹ at the same time to obtain equations M⁻¹Ax=M⁻¹b. After multiplying M⁻¹ and A, a magnitude difference of elements in an original matrix A is balanced, a condition number of the matrix A is reduced, and the easy-to-solvable equation is obtained. For details on a calculation method of the large condition number matrix inversion, reference is made to Benzi, Michele. “Preconditioning Techniques for Large Linear Systems: A Survey.” Journal of Computational Physics 182, no. 2 (2002/11/01/2002): 418-77.

### SUMMARY

A method for estimating a reactive ion flux and a potential inside a lithium-ion battery includes:
(1) obtaining a port current and a port temperature of the battery; obtaining an electrode parameter of the battery; setting coordinates of points to be analyzed inside the battery; obtaining a concentration of lithium ions in an electrolyte at the points to be analyzed inside the battery; obtaining a concentration of lithium ions on a surface of an electrode active material at the points to be analyzed inside the battery; obtaining a volume fraction of the electrode active material at the points to be analyzed inside the battery; obtaining lateral resistivity of a solid electrolyte film on the surface of the electrode active material at the points to be analyzed inside the battery; and obtaining a volume fraction of the electrolyte at the points to be analyzed inside the battery;
(2) calculating reaction rate constants of positive and negative electrodes of the battery; calculating a conductivity of the electrolyte at the points to be analyzed inside the battery; calculating a polarization coefficient of the electrolyte at the points to be analyzed inside the battery; and calculating a surface equilibrium potential on a surface of an active material at the points to be analyzed inside the battery;
(3) calculating a surface area to volume ratio of the electrode active material in a negative electrode region; calculating an average ion flux in the negative electrode region; calculating an ion flux of a benchmark reaction at the points to be analyzed in the negative electrode region; calculating a first-order Taylor expansion at the average ion flux of a Butler-Volmer equation at the points to be analyzed in the negative electrode region; calculating an intermediate parameter of a spatial distribution expression of the reactive ion flux in the negative electrode region; calculating a parameter of the spatial distribution expression of the reactive ion flux in the negative electrode region; calculating a spatial distribution function of the reactive ion flux between the points to be analyzed in the negative electrode region; and calculating the reactive ion flux at the points to be analyzed in the negative electrode region;
(4) calculating a surface area to volume ratio of the electrode active material in a positive electrode region; calculating an average ion flux in the positive electrode region; calculating an ion flux of a benchmark reaction at the points to be analyzed in the positive electrode region; calculating a first-order Taylor expansion at the average ion flux of a Butler-Volmer equation at the points to be analyzed in the positive electrode region; calculating an intermediate parameter of a spatial distribution expression of the reactive ion flux in the positive electrode region; calculating a parameter of the spatial distribution expression of the reactive ion flux in the positive electrode region; calculating a spatial distribution function of the reactive ion flux between the points to be analyzed in the positive electrode region; and calculating the reactive ion flux at the points to be analyzed in the positive electrode region; and
(5) calculating a potential distribution function and a voltage drop of the electrolyte between the points to be analyzed in the negative electrode region; calculating a potential distribution function and a voltage drop of the electrolyte between the points to be analyzed in the positive electrode region; calculating a voltage drop of the electrolyte in a separator region; and calculating a voltage drop of the electrolyte in the battery.

### BRIEF DESCRIPTION OF THE DRAWINGS

FIG. 1 is a flowchart of a method for estimating a reactive ion flux and a potential inside a lithium-ion battery provided in the present disclosure.

FIG. 2 is a schematic diagram of coordinate positions of points to be analyzed.

### DETAILED DESCRIPTION

A method for estimating a reactive ion flux and a potential of a lithium-ion battery provided in the present disclosure will be described below in conjunction with accompanying drawings.

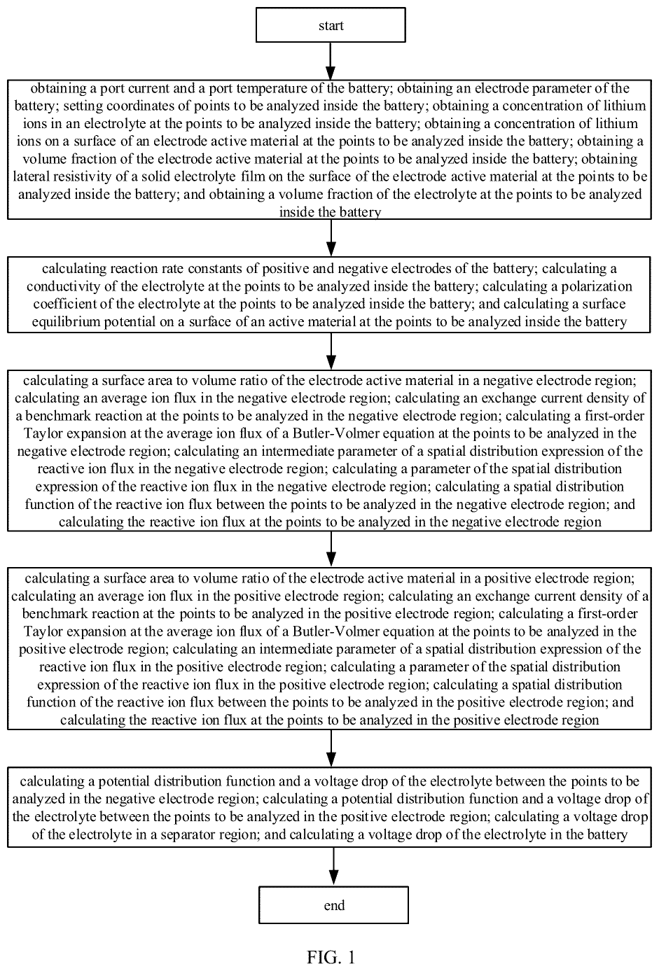

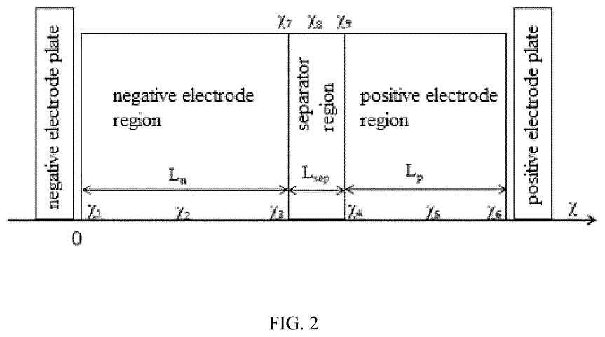

As shown in FIG. 1 and FIG. 2, the method specifically includes step (1) to step (5) as follows.

(1) A port current and a port temperature of the battery are obtained; an electrode parameter of the battery is obtained; coordinates of points to be analyzed inside the battery are set; a concentration of lithium ions in an electrolyte at the points to be analyzed inside the battery is obtained; a concentration of lithium ions on a surface of an electrode active material at the points to be analyzed inside the battery is obtained; a volume fraction of the electrode active material at the points to be analyzed inside the battery is obtained; lateral resistivity of a solid electrolyte film on the surface of the electrode active material at the points to be analyzed inside the battery is obtained; and a volume fraction of the electrolyte at the points to be analyzed inside the battery is obtained. A specific process thereof includes as follows.

(1.1) The port current and the port temperature of the battery are obtained, denoted as I and T respectively, with units being A and K respectively. A current symbol is positive when the battery is discharged, and negative when charged.

(1.2) Relevant electrode parameters of the battery are obtained according to information of a manufacturer queried based on a battery type or according to an electrochemical model of the lithium-ion battery. The relevant electrode parameters include: a thickness Lₙ of the negative electrode, a thickness Lₛₑₚ of the separator, a thickness Lₚ of the positive electrode, with units being m; a particle radius R_{s,n} of a negative electrode active material, a particle radius R_{s,p} of a positive electrode active material, with units being m; and an equivalent cross-sectional area Aₙ of the negative electrode, an equivalent cross-sectional area Aₚ of the positive electrode, an equivalent cross-sectional area Aₛₑₚ of the separator, with units being m².

(1.3) The coordinates of the points to be analyzed inside the battery are set. Three points are each selected in the negative electrode region and the positive electrode region as the points to be analyzed according to a characteristic of a chemical reaction inside the battery, and are respectively
a point of the negative electrode region close to a negative electrode plate with a coordinate x₁=0, a midpoint of the negative electrode region with a coordinate x₂=Lₙ/2, and a point of the negative electrode region close to the separator region with a coordinate x₃=Lₙ, and
a point of the positive electrode region close to the separator region with a coordinate x₄=Lₙ+Lₛₑₚ, a midpoint of the positive electrode region with a coordinate x₅=Lₙ+Lₛₑₚ+Lₚ/2, and a point of the positive electrode region close to a positive electrode plate with a coordinate x₆=Lₙ+Lₛₑₚ+Lₚ.

In addition, three points are also selected in the separator region as the points to be analyzed, and are an interface between the separator region and the negative electrode region with a coordinate x₇=Lₙ, a midpoint of the separator region with a coordinate x₈=Lₙ+Lₛₑₚ/2, and an interface between the separator region and the positive electrode region with a coordinate x₉=Lₙ+Lₛₑₚ, respectively.

(1.4) A concentration of the lithium ions in the electrolyte at a point [x₁,x₂,x₃,x₄,x₅,x₆,x₇,x₈,x₉] is obtained according to the electrochemical model of the lithium-ion battery, denoted as [c_{e,1},c_{e,2},c_{e, 3},c_{e, 4},c_{e, 5},c_{e, 6},c_{e, 7},c_{e,8},c_{e, 9}], with a unit being mol/m³.

(1.5) A concentration of the lithium ions on the surface of the electrode active material at a point [x₁,x₂,x₃,x₄,x₅,x₆] is obtained according to the electrochemical model of the lithium-ion battery, denoted as [c_{e,1},c_{e,2},c_{e,3},c_{e,4},c_{e,5},c_{e,6}], with a unit being mol/m³.

(1.6) A volume fraction of the active material at the point [x₁,x₂,x₃,x₄,x₅,x₆] is obtained according to the information of the manufacturer or an aging model of the lithium-ion battery, denoted as [ε_{a,1},ε_{a,2}ε_{a,3}ε_{a,4}ε_{a,5}ε_{a,6}], and is dimensionless.

(1.7) Lateral resistivity of the solid electrolyte film on the surface of the active material at the point [x₁,x₂,x₃,x₄,x₅,x₆] is obtained according to the information of the manufacturer or the aging model of the lithium-ion battery, denoted as [R_{ƒ,1},R_{ƒ,2},R_{ƒ,3},R_{ƒ,4},R_{ƒ,5},R_{ƒ,6}], with a unit being Q m².

(1.8) A volume fraction of the electrolyte at the point [x₁,x₂,x₃,x₄,x₅,x₆,x₇,x₈,x₉] is obtained according to the information of the manufacturer or the aging model of the lithium-ion battery, denoted as [ε_{e,1},ε_{e,2},ε_{e,3},ε_{e,4},ε_{e,5},ε_{e,6},ε_{e,7},ε_{e,8},ε_{e,9}], and is dimensionless.

(2) Reaction rate constants of positive and negative electrodes of the battery are calculated; a conductivity of the electrolyte at the points to be analyzed inside the battery is calculated; a polarization coefficient of the electrolyte at the points to be analyzed inside the battery is calculated; and a surface equilibrium potential on a surface of an active material at the points to be analyzed inside the battery is calculated. A specific process thereof includes as follows.

(2.1) The reaction rate constants of the positive electrode and the negative electrode are calculated according to a material property of the electrode and a temperature of the battery. The reaction rate constant of the positive electrode in a standard state (T_{ref}=298.15K) is denoted as k_{r,p,ref}, and the reaction rate constant of the negative electrode in the standard state (T_{ref}=298.15K) is denoted as k_{r,n,ref}, with units being A·m^{2.5}/mol^{1.5}. A reaction rate activation energy of the positive electrode is E_{r,p}, and a reaction rate activation energy of the negative electrode is E_{r,n}, with units being J/mol. Values of common electrode reaction parameters k_{r,p/n,ref} and E_{r,p/n} for the lithium-ion battery are shown in Table 1. Then, the reaction rate constants of the negative electrode and the positive electrode at a current temperature T are respectively:

$${k}_{r , n} = exp ( - {E}_{r , n} / R / T + {E}_{r , n} / R / {T}_{ref} + ln ( {k}_{r , n , ref} ) ) ; and$$

$${k}_{r , p} = exp ( - {E}_{r , p} / R / T + {E}_{r , p} / R / {T}_{ref} + ln ( {k}_{r , p , ref} ) ) ;$$

where an ideal gas constant R=8.314 J/mol/K.

TABLE 1
Reaction parameters of common electrode active
materials for the lithium-ion battery

| | Reaction rate constant | |
|---|---|---|
| | in standard state | Reaction rate constant |
| | (k_{r, p/n, ref} | activation energy |
| Active materials | A · m^{2.5}/mol^{1.5}) | (E_{r, p/n} J/mol ) |
| Negative electrode of | 2.23 × 1e−5 | 67995 |
| graphite (GRAPHITE) | | |
| Positive electrode of | 2.32 × 1e−6 | 51997 |
| ternary (NCM523) | | |
| Positive electrode of | 2.34 × 1e−6 | 51998 |
| ternary (NCM811) | | |
| Positive electrode of | 5.06 × 1e−6 | 31997 |
| ferric phosphate (LFPO) | | |

(2.2) The conductivity of the electrolyte at the points to be analyzed is calculated according to a material property of the electrolyte, a relationship between the conductivity of the electrolyte and a lithium concentration in the electrolyte is denoted as: κ_{ref}=ƒ_{κ}(cₑ,T), with a unit being S/m. The conductivity function of common materials of the electrolyte for the lithium-ion battery is shown in Table 2, then the conductivity of the electrolyte at each point to be analyzed is:

$${κ}_{i} = {f}_{κ} ( {c}_{e , i} , T ) \times {ε}_{e , i}^{p} , i = 1 , 2 , … , 9 ;$$

where p is a Bruggeman correction coefficient, p=1.5.

(2.3) The polarization coefficient of the electrolyte at the points to be analyzed is calculated according to the material property of the electrolyte:

$${κ}_{D , i} = \frac{2 RT ( {t}_{0}^{+} - 1 )}{F} {κ}_{i} ( 1 + {f}_{κ D} ( {c}_{e , i} ) ) , i = 1 , 2 , … , 9 ;$$

where a Faraday constant F=96485 C/mol, an ion mobility number t₀⁺=0.38, and a polarization function ƒ_{κD}(cₑ) depends on the material of the electrolyte, and is dimensionless. The polarization function of the common materials of the electrolyte for the lithium-ion battery is shown in Table 2.

TABLE 2
Conductivity function of common electrolytes for the lithium-ion battery

| Materials of | |
|---|---|
| electrolyte | EC-EMC-DMC |
| f_{κ}(cₑ,T) S/m | $\frac{{c}_{e}}{{10}^{4}} {( ( \frac{0.494}{{10}^{6}} {c}_{e}^{2} + \frac{0.668}{{10}^{3}} {c}_{e} - 10.5 ) + ( \frac{- 8.86}{{10}^{10}} {c}_{e}^{2} - \frac{1.78}{{10}^{5}} {c}_{e} + 0.74 ) T + ( \frac{2.8}{{10}^{8}} {c}_{e} - \frac{6.96}{{10}^{5}} ) {T}^{2} )}^{2}$ |
| f_{κD}(cₑ) dimensionless | $\frac{2.511}{1000} {c}_{e} - 1.333$ |

Note: cₑ takes a value when a unit is mol/m³.

(2.4) A type of active materials used in the positive and negative electrodes is obtained, and a functional relationship between a reaction equilibrium potential of the active materials, a lithium intercalation rate, and an electrode temperature is queried, in which the positive electrode is denoted as ƒ_{OCP,p}(x;T), and the negative electrode is denoted as ƒ_{OCP,n}(x;T). Maximum lithium concentrations that the positive and negative electrode active materials can accommodate respectively are calculated: c_{s,p/n}^{max}=ρ_{p/n}/M_{p/n}, where ρ is a density of the active materials, with a unit being kg/m³, and M is a relative molar mass of the active materials, with a unit being kg/mol. Material parameters of common electrode active materials for the lithium-ion battery is shown in Table 3. The surface equilibrium potentials on the surfaces of the active materials for three points to be analyzed in the negative electrode region and three points to be analyzed in the positive electrode region are calculated, with a unit being V:

$${U}_{OCP , i} = {f}_{OCP , n} ( \frac{{c}_{s , i}}{{c}_{s , n}^{max}} ; T ) , i = 1 , 2 , 3 ; and$$

$${U}_{OCP , i} = {f}_{OCP , p} ( \frac{{c}_{s , i}}{{c}_{s , p}^{max}} ; T ) , i = 4 , 5 , 6.$$

TABLE 3
Material parameters of common electrode active
materials for the lithium-ion battery

| | | Relative |
|---|---|---|
| | Density | molar mass |
| Active materials | (kg/m³) | (kg/mol) |
| Negative electrode of | 2.24 × 10³ | 72.06 × 10⁻³ |
| graphite (GRAPHITE) | | |
| Positive electrode of ternary (NCM523) | 4.8 × 10³ | 96.554 × 10⁻³ |
| Positive electrode of ternary (NCM811) | 4.8 × 10³ | 97.28 × 10⁻³ |
| Positive electrode of ferric | 3.6 × 10³ | 157.751 × 10⁻³ |
| phosphate (LFPO) | | |

(3) A surface area to volume ratio of the electrode active material in a negative electrode region is calculated; an average ion flux in the negative electrode region is calculated; an exchange current density of a benchmark reaction at the points to be analyzed in the negative electrode region is calculated; a first-order Taylor expansion at the average ion flux of a Butler-Volmer equation at the points to be analyzed in the negative electrode region is calculated; an intermediate parameter of a spatial distribution expression of the reactive ion flux in the negative electrode region is calculated; a parameter of the spatial distribution expression of the reactive ion flux in the negative electrode region is calculated; a spatial distribution function of the reactive ion flux between the points to be analyzed in the negative electrode region is calculated; and the reactive ion flux at the points to be analyzed in the negative electrode region is calculated. A specific process thereof includes as follows.

(3.1) A surface area to volume ratio (unit: 1/m) and a surface area to volume ratio average value of particles in the active material at the points to be analyzed in the negative electrode region are calculated:

$${a}_{s , i} = \frac{3 {ε}_{s , i}}{{R}_{s , n}} , i = 1 , 2 , 3 ; and$$

$${a}_{s , n , av} = \frac{{a}_{s , 1} + {a}_{s , 2} + {a}_{s , 3}}{3} .$$

(3.2) The average ion flux (unit: mol/m²/s) in the negative electrode region is calculated:

$${j}_{n , n , av} = \frac{I}{{a}_{s , n , av} {A}_{n} {L}_{n} F} .$$

(3.3) The exchange current density (unit: A/m²) of the benchmark reaction at the points to be analyzed in the negative electrode region is calculated:

$${i}_{0 , i} = {k}_{r , n} \sqrt{{c}_{e , i} {c}_{s , i} ( {c}_{s , n}^{max} - {c}_{s , i} )} , i = 1 , 2 , 3.$$

(3.4) The first-order Taylor expansion at j_{n,n,av} of the Butler-Volmer equation at the points to be analyzed in the negative electrode region is calculated, and its slope a_{j,i} and intercept b_{j,i} are obtained:

$${a}_{j , i} = \frac{RT}{{i}_{0 , i}} \frac{\sqrt{\frac{{F}^{2} {j}_{n , n , av}^{2}}{4 {i}_{0 , i}^{2}} + 1} + \frac{{Fj}_{n , n , av}}{2 {i}_{0 , i}}}{\frac{{Fj}_{n , n , av}}{2 {i}_{0 , i}} \sqrt{\frac{{F}^{2} {j}_{n , n , av}^{2}}{4 {i}_{0 , i}^{2}} + 1} + \frac{{F}^{2} {j}_{n , n , av}^{2}}{4 {i}_{0 , i}^{2}} + 1} , i = 1 , 2 , 3 ; and$$

$${b}_{j , i} = - {j}_{n , n , av} {a}_{j , i} + \frac{2 RT}{F} ln ( \frac{{Fj}_{n , n , av}}{2 {i}_{0 , i}} + \sqrt{\frac{{F}^{2} {j}_{n , n , av}^{2}}{4 {i}_{0 , i}^{2}} + 1} ) , i = 1 , 2 , 3.$$

(3.5) Relevant variable gradients at the points to be analyzed in the negative electrode region are calculated, including a logarithmic function gradient of a lithium ion concentration in the electrolyte, a surface equilibrium potential gradient of the active material, a slope gradient and an intercept gradient in (3.4), and a lateral resistivity gradient of the solid electrolyte film, in which
at a point i=1, gradients are obtained by following formulas:

$${{dce}_{1} = \frac{\partial ln ( {c}_{e} )}{\partial x} \vert}_{x = {x}_{1}} = \frac{- 3 ln ( {c}_{e , 1} ) + 4 ln ( {c}_{e , 2} ) - ln ( {c}_{e , 3} )}{{x}_{3} - {x}_{1}} ;$$

$${{docp}_{1} = \frac{\partial ( {U}_{OCP} )}{\partial x} \vert}_{x = {x}_{1}} = \frac{- 3 {U}_{OCP , 1} + 4 {U}_{OCP , 2} - {U}_{OCP , 3}}{{x}_{3} - {x}_{1}} ;$$

$${{daj}_{1} = \frac{\partial ( {a}_{j} )}{\partial x} \vert}_{x = {x}_{1}} = \frac{- 3 {a}_{j , 1} + 4 {a}_{j , 2} - {a}_{j , 3}}{{x}_{3} - {x}_{1}} ;$$

$${{dbj}_{1} = \frac{\partial ( {b}_{j} )}{\partial x} \vert}_{x = {x}_{1}} = \frac{- 3 {b}_{j , 1} + {4}_{j , 2} - {b}_{j , 3}}{{x}_{3} - {x}_{1}} ; and$$

$${{dR}_{f , 1} = \frac{\partial ( {R}_{f} )}{\partial x} \vert}_{x = {x}_{1}} = \frac{- 3 {R}_{f , 1} + 4 {R}_{f , 2} - {R}_{f , 3}}{{x}_{3} - {x}_{1}} ;$$

at a point i=2, gradients are obtained by following formulas:

$${{dce}_{2} = \frac{\partial ln ( {c}_{e} )}{\partial x} \vert}_{x = {x}_{2}} = \frac{ln ( {c}_{e , 3} ) - ln ( {c}_{e , 1} )}{{x}_{3} - {x}_{1}} ;$$

$${{docp}_{2} = \frac{\partial ( {U}_{OCP} )}{\partial x} \vert}_{x = {x}_{2}} = \frac{{U}_{OCP , 3} - {U}_{OCP , 1}}{{x}_{3} - {x}_{1}} ;$$

$${{daj}_{2} = \frac{\partial ( {a}_{j} )}{\partial x} \vert}_{x = {x}_{2}} = \frac{{a}_{j , 3} - {a}_{j , 1}}{{x}_{3} - {x}_{1}} ;$$

$${{dbj}_{2} = \frac{\partial ( {b}_{j} )}{\partial x} \vert}_{x = {x}_{2}} = \frac{{b}_{j , 3} - {b}_{j , 1}}{{x}_{3} - {x}_{1}} ; and$$

$${{dR}_{f , 2} = \frac{\partial ( {R}_{f} )}{\partial x} \vert}_{x = {x}_{2}} = \frac{{R}_{f , 3} - {R}_{f , 1}}{{x}_{3} - {x}_{1}} ; and$$

at a point i=3, gradients are obtained by following formulas:

$${{dce}_{3} = \frac{\partial ln ( {c}_{e} )}{\partial x} \vert}_{x = {x}_{3}} = \frac{ln ( {c}_{e , 1} ) - 4 ln ( {c}_{e , 2} ) + 3 ln ( {c}_{e , 3} )}{{x}_{3} - {x}_{1}} ;$$

$${{docp}_{3} = \frac{\partial ( {U}_{OCP} )}{\partial x} \vert}_{x = {x}_{3}} = \frac{{U}_{OCP , 1} - 4 {U}_{OCP , 2} + 3 {U}_{OCP , 3}}{{x}_{3} - {x}_{1}} ;$$

$${{dbj}_{3} = \frac{\partial ( {b}_{j} )}{\partial x} \vert}_{x = {x}_{3}} = \frac{{b}_{j , 1} - 4 {b}_{j , 2} + 3 {b}_{j , 3}}{{x}_{3} - {x}_{1}} ;$$

$${{dbj}_{3} = \frac{\partial ( {b}_{j} )}{\partial x} \vert}_{x = {x}_{3}} = \frac{{b}_{j , 1} - {4}_{j , 2} + 3 {b}_{j , 3}}{{x}_{3} - {x}_{1}} ; and$$

$${{dR}_{f , 3} = \frac{\partial ( {R}_{f} )}{\partial x} \vert}_{x = {x}_{3}} = \frac{{R}_{f , 1} - 4 {R}_{f , 2} + 3 {R}_{f , 3}}{{x}_{3} - {x}_{1}} .$$

(3.6) Five intermediate parameters of the spatial distribution function of the reactive ion flux in the negative electrode region are calculated, and first the intermediate parameters at each point to be analyzed are calculated:

$${k}_{1 , i} = {Fa}_{s , i} ( \frac{1}{{σ}_{s , n}} + \frac{1}{{κ}_{i}} ) , i = 1 , 2 , 3 ;$$

$${k}_{2 , i} = F \cdot {dR}_{f , i} + {da}_{j , i} , i = 1 , 2 , 3 ;$$

$${k}_{3 , i} = F \cdot {R}_{f , i} + {a}_{j , i} , i = 1 , 2 , 3 ;$$

$${k}_{4 , i} = \frac{{κ}_{D , i}}{{κ}_{i}} \cdot {dce}_{i} - {docp}_{i} - {db}_{j , i} - \frac{I}{{A}_{n} {σ}_{s , n}} , i = 1 , 2 , 3 ; and$$

$${k}_{5 , i} = - \frac{{Fa}_{s , i}}{{κ}_{i}} , i = 1 , 2 , 3 ;$$

and
a region between the points i=1 and i=2 to be analyzed is denoted as A, a region between the points i=2 and i=3 to be analyzed is denoted as B, and intermediate parameters corresponding to the regions are calculated:

$${k}_{1 , A} = \frac{{k}_{1 , 1} + {k}_{1 , 2}}{2} ,$$

$${k}_{2 , A} = \frac{{k}_{2 , 1} + {k}_{2 , 2}}{2} ,$$

$${k}_{3 , A} = \frac{{k}_{3 , 1} + {k}_{3 , 2}}{2} ,$$

$${k}_{4 , A} = \frac{{k}_{4 , 1} + {k}_{4 , 2}}{2} ,$$

$${k}_{5 , A} = \frac{{k}_{5 , 1} + {k}_{5 , 2}}{2} ,$$

$${k}_{1 , B} = \frac{{k}_{1 , 2} + {k}_{1 , 3}}{2} ,$$

$${k}_{2 , B} = \frac{{k}_{2 , 2} + {k}_{2 , 3}}{2} ,$$

$${k}_{3 , B} = \frac{{k}_{3 , 2} + {k}_{3 , 3}}{2} ,$$

$${k}_{4 , A} = \frac{{k}_{4 , 2} + {k}_{4 , 3}}{2} , and$$

$${k}_{5 , B} = \frac{{k}_{5 , 2} + {k}_{5 , 3}}{2} .$$

(3.7) Parameters of the spatial distribution function of the reactive ion flux in the region A and the region B may be calculated by following formulas:

$${λ}_{1 , A} = - \frac{\sqrt{4 {k}_{1 , A} \cdot {k}_{3 , A} + {k}_{2 , A}^{2}} + {k}_{2 , A}}{2 {k}_{3 , A}} ,$$

$${λ}_{2 , A} = \frac{\sqrt{4 {k}_{1 , A} \cdot {k}_{3 , A} + {k}_{2 , A}^{2}} - {k}_{2 , A}}{2 {k}_{3 , A}} ;$$

$${λ}_{1 , B} = - \frac{\sqrt{4 {k}_{1 , B} \cdot {k}_{3 , B} + {k}_{2 , B}^{2}} + {k}_{2 , B}}{2 {k}_{3 , B}} ,$$

$${λ}_{2 , B} = \frac{\sqrt{4 {k}_{1 , B} \cdot {k}_{3 , B} + {k}_{2 , B}^{2}} - {k}_{2 , B}}{2 {k}_{3 , B}} ;$$

$${M}_{n} = [ \begin{matrix}1 & 1 & 0 & 0 & 0 \\ 0 & 0 & {e}^{{λ}_{1 , B} {L}_{n} / 2} & {e}^{{λ}_{2 , B} {L}_{n} / 2} & 1 \\ {e}^{{λ}_{1 , A} {L}_{n} / 2} & {e}^{{λ}_{2 , A} {L}_{n} / 2} & 0 & 0 & 1 \\ {λ}_{1 , A} {e}^{{λ}_{1 , A} {L}_{n} / 2} & {λ}_{2 , A} {e}^{{λ}_{2 , A} {L}_{n} / 2} & - {λ}_{1 , B} {e}^{{λ}_{1 , B} {L}_{n} / 2} & - {λ}_{2 , B} {e}^{{λ}_{2 , B} {L}_{n} / 2} & 0 \\ {e}^{{λ}_{1 , A} {L}_{n} / 2} & {e}^{{λ}_{2 , A} {L}_{n} / 2} & {e}^{{λ}_{1 , B} {L}_{n}} & {e}^{{λ}_{2 , B} {L}_{n}} & 1\end{matrix} ] ; and$$

$$[ \begin{matrix}{m}_{1 , A} \\ {m}_{2 , A} \\ {m}_{1 , B} \\ {m}_{2 , B} \\ {m}_{3 , B}\end{matrix} ] = {M}_{n}^{- 1} [ \begin{matrix}\frac{{k}_{4 , A}}{{k}_{1 , A}} \\ 0 \\ \frac{{k}_{4 , A}}{{k}_{1 , A}} - \frac{{k}_{4 , B}}{{k}_{1 , B}} \\ 0 \\ \frac{{k}_{4 , A}}{{k}_{1 , A}} + \frac{I}{{A}_{n} {Fa}_{s , n , av}}\end{matrix} ] .$$

If a condition number of a matrix Mₙ is too large in practical applications, a balance method can be used for inversion to reduce an error. The spatial distribution expressions of the reactive ion flux in the regions A and B are respectively:

$${j}_{n , A} ( x ) = {m}_{1 , A} {λ}_{1 , A} {e}^{{λ}_{1 , A} x} + {m}_{2 , A} {λ}_{2 , A} {e}^{{λ}_{2 , A} x} ; and$$

$${j}_{n , B} ( x ) = {m}_{1 , B} {λ}_{1 , B} {e}^{{λ}_{1 , B} x} + {m}_{2 , B} {λ}_{2 , B} {e}^{{λ}_{2 , B} x} .$$

By substituting a coordinate of a point to be analyzed into a corresponding formula in the above two formulas, the reactive ion flux at the point to be analyzed can be obtained:

$${j}_{n , 1} = {m}_{1 , A} {λ}_{1 , A} + {m}_{2 , A} {λ}_{2 , A} ;$$

$${j}_{n , 2} = {m}_{1 , A} {λ}_{1 , A} {e}^{{λ}_{1 , A} {L}_{n / 2}} + {m}_{2 , A} {λ}_{2 , A} {e}^{{λ}_{2 , A} {L}_{n} / 2} ; and$$

$${j}_{n , 3} = {m}_{1 , B} {λ}_{1 , B} {e}^{{λ}_{1 , B} {L}_{n}} + {m}_{2 , B} {λ}_{2 , B} {e}^{{λ}_{2 , B} {L}_{n}} .$$

(4) A surface area to volume ratio of the electrode active material in a positive electrode region is calculated; an average ion flux in the positive electrode region is calculated; an exchange current density of a benchmark reaction at the points to be analyzed in the positive electrode region is calculated; a first-order Taylor expansion at the average ion flux of a Butler-Volmer equation at the points to be analyzed in the positive electrode region is calculated; an intermediate parameter of a spatial distribution expression of the reactive ion flux in the positive electrode region is calculated; a parameter of the spatial distribution expression of the reactive ion flux in the positive electrode region is calculated; a spatial distribution function of the reactive ion flux between the points to be analyzed in the positive electrode region is calculated; and the reactive ion flux at the points to be analyzed in the positive electrode region is calculated. A specific process thereof includes as follows.

(4.1) A surface area to volume ratio (unit: 1/m) and a surface area to volume ratio average value of particles of an active material at the points to be analyzed in the positive electrode region are calculated:

$${a}_{s , i} = \frac{3 {ε}_{s , i}}{{R}_{s , p}} , i = 4 , 5 , 6 ; and$$

$${a}_{s , p , av} = \frac{{a}_{s , 4} + {a}_{s , 5} + {a}_{s , 6}}{3} .$$

(4.2) The average ion flux (unit: mol/m²/s) in the positive electrode region is calculated:

$${j}_{n , p , av} = - \frac{I}{{a}_{s , p , av} {A}_{p} {L}_{p} F} .$$

(4.3) The exchange current density (unit: A/m²) of the benchmark reaction at the points to be analyzed in the positive electrode region is calculated:

$${i}_{0 , i} = {k}_{r , p} \sqrt{{c}_{e , i} {c}_{s , i} ( {c}_{s , p}^{max} - {c}_{s , i} )} , i = 4 , 5 , 6.$$

(4.4) The first-order Taylor expansion at j_{n,p,av} of the Butler-Volmer equation at the points to be analyzed in the positive electrode region is calculated, and its slope a_{j,i} and intercept b_{j,i} are obtained:

$${a}_{j , i} = \frac{RT}{{i}_{0 , i}} \frac{\sqrt{\frac{{F}^{2} {j}_{n , p , av}^{2}}{4 {i}_{0 , i}^{2}} + 1} + \frac{{Fj}_{n , p , av}}{2 {i}_{0 , i}}}{\frac{{Fj}_{n , p , av}}{2 {i}_{0 , i}} \sqrt{\frac{{F}^{2} {j}_{n , p , av}^{2}}{4 {i}_{0 , i}^{2}} + 1} + \frac{{F}^{2} {j}_{n , p , av}^{2}}{4 {i}_{0 , i}^{2}} + 1} , i = 4 , 5 , 6 ; and$$

$${b}_{j , i} = - {j}_{n , p , av} {a}_{j , i} + \frac{2 RT}{F} ln ( \frac{{Fj}_{n , p , av}}{2 {i}_{0 , i}} + \sqrt{\frac{{F}^{2} {j}_{n , p , av}^{2}}{4 {i}_{0 , i}^{2}} + 1} ) , i = 4 , 5 , 6.$$

(4.5) Relevant variable gradients at the points to be analyzed in the positive electrode region are calculated, including a logarithmic function gradient of a lithium ion concentration in the electrolyte, a surface equilibrium potential gradient of the active material, a slope gradient and an intercept gradient in (4.4), and a lateral resistivity gradient of the solid electrolyte film, in which
at a point i=4, gradients are obtained by following formulas:

$${{dce}_{4} = \frac{\partial ln ( {c}_{e} )}{\partial x} \vert}_{x = {x}_{4}} = \frac{- 3 ln ( {c}_{e , 4} ) + 4 ln ( {c}_{e , 5} ) - ln ( {c}_{e , 6} )}{{x}_{6} - {x}_{4}} ;$$

$${{docp}_{4} = \frac{\partial ( {U}_{OCP} )}{\partial x} \vert}_{x = {x}_{4}} = \frac{- 3 {U}_{OCP , 4} + 4 {U}_{OCP , 5} - {U}_{OCP , 6}}{{x}_{6} - {x}_{4}} ;$$

$${{daj}_{4} = \frac{\partial ( {a}_{j} )}{\partial x} \vert}_{x = {x}_{4}} = \frac{- 3 {a}_{j , 4} + 4 {a}_{j , 5} - {a}_{j , 6}}{{x}_{6} - {x}_{4}} ;$$

$${{dbj}_{4} = \frac{\partial ( {b}_{j} )}{\partial x} \vert}_{x = {x}_{4}} = \frac{- 3 {b}_{j , 4} + 4 {b}_{j , 5} - {b}_{j , 6}}{{x}_{6} - {x}_{4}} ; and$$

$${{dR}_{f , 4} = \frac{\partial ( {R}_{f} )}{\partial x} \vert}_{x = {x}_{4}} = \frac{- 3 {R}_{f , 4} + 4 {R}_{f , 5} - {R}_{f , 6}}{{x}_{6} - {x}_{4}} ;$$

at a point i=5, gradients are obtained by following formulas:

$${{dce}_{5} = \frac{\partial ln ( {c}_{e} )}{\partial x} \vert}_{x = {x}_{5}} = \frac{ln ( {c}_{e , 6} ) - ln ( {c}_{e , 4} )}{{x}_{6} - {x}_{4}} ;$$

$${{docp}_{5} = \frac{\partial ( {U}_{OCP} )}{\partial x} \vert}_{x = {x}_{5}} = \frac{{U}_{OCP , 6} - {U}_{OCP , 4}}{{x}_{6} - {x}_{4}} ;$$

$${{daj}_{5} = \frac{\partial ( {a}_{j} )}{\partial x} \vert}_{x = {x}_{5}} = \frac{{a}_{j , 6} - {a}_{j , 4}}{{x}_{6} - {x}_{4}} ;$$

$${{dbj}_{5} = \frac{\partial ( {b}_{j} )}{\partial x} \vert}_{x = {x}_{5}} = \frac{{b}_{j , 6} - {b}_{j , 4}}{{x}_{6} - {x}_{4}} ; and$$

$${{dR}_{f , 5} = \frac{\partial ( {R}_{f} )}{\partial x} \vert}_{x = {x}_{5}} = \frac{{R}_{f , 6} - {R}_{f , 4}}{{x}_{6} - {x}_{4}} ;$$

at a point i=6, gradients are obtained by following formulas:

$${{dce}_{6} = \frac{\partial ln ( {c}_{e} )}{\partial x} \vert}_{x = {x}_{6}} = \frac{ln ( {c}_{e , 4} ) - 4 ln ( {c}_{e , 5} ) + 3 ln ( {c}_{e , 6} )}{{x}_{6} - {x}_{4}} ;$$

$${{docp}_{6} = \frac{\partial ( {U}_{OCP} )}{\partial x} \vert}_{x = {x}_{6}} = \frac{{U}_{OCP , 4} - 4 {U}_{OCP , 5} + 3 {U}_{OCP , 6}}{{x}_{6} - {x}_{4}} ;$$

$${{dbj}_{6} = \frac{\partial ( {b}_{j} )}{\partial x} \vert}_{x = {x}_{6}} = \frac{{b}_{j , 4} - 4 {b}_{j , 5} + 3 {b}_{j , 6}}{{x}_{6} - {x}_{4}} ;$$

$${{dbj}_{6} = \frac{\partial ( {b}_{j} )}{\partial x} \vert}_{x = {x}_{6}} = \frac{{b}_{j , 4} - 4 {b}_{j , 5} + 3 {b}_{j , 6}}{{x}_{6} - {x}_{4}} ; and$$

$${{dR}_{f , 6} = \frac{\partial ( {R}_{f} )}{\partial x} \vert}_{x = {x}_{6}} = \frac{{R}_{f , 6} - 4 {R}_{f , 5} + 3 {R}_{f , 6}}{{x}_{6} - {x}_{4}} .$$

(4.6) Five intermediate parameters of the spatial distribution function of the reactive ion flux in the positive electrode region are calculated, and first the intermediate parameters at each point to be analyzed are calculated:

$${k}_{1 , i} = - {Fa}_{s , i} ( \frac{1}{{σ}_{s , p}} + \frac{1}{{k}_{i}} ) , i = 4 , 5 , 6 ;$$

$${k}_{2 , i} = F \cdot {dR}_{f , i} + {da}_{j , i} , i = 4 , 5 , 6 ;$$

$${k}_{3 , i} = F \cdot {R}_{f , i} + {a}_{j , i} , i = 4 , 5 , 6 ;$$

$${k}_{4 , i} = \frac{{κ}_{D , i}}{{κ}_{i}} \cdot {dce}_{i} - {docp}_{i} - {bd}_{j , i} - \frac{I}{{A}_{p} {σ}_{s , p}} , i = 4 , 5 , 6 ; and$$

$${k}_{5 , i} = \frac{{Fa}_{s , i}}{{κ}_{i}} , i = 4 , 5 , 6.$$

A region between the points i=4 and i=5 to be analyzed is denoted as C, a region between the points i=5 and i=6 to be analyzed is denoted as D, and intermediate parameters corresponding to the regions are calculated:

$${k}_{1 , C} = \frac{{k}_{1 , 4} + {k}_{1 , 5}}{2} ,$$

$${k}_{2 , C} = \frac{{k}_{2 , 4} + {k}_{2 , 5}}{2} ,$$

$${k}_{3 , C} = \frac{{k}_{3 , 4} + {k}_{3 , 5}}{2} ,$$

$${k}_{4 , C} = \frac{{k}_{4 , 4} + {k}_{4 , 5}}{2} ,$$

$${k}_{5 , C} = \frac{{k}_{5 , 4} + {k}_{5 , 5}}{2} ;$$

$${k}_{1 , D} = \frac{{k}_{1 , 5} + {k}_{1 , 6}}{2} ,$$

$${k}_{2 , D} = \frac{{k}_{2 , 5} + {k}_{2 , 6}}{2} ,$$

$${k}_{3 , D} = \frac{{k}_{3 , 5} + {k}_{3 , 6}}{2} ,$$

$${k}_{4 , D} = \frac{{k}_{4 , 5} + {k}_{4 , 6}}{2} , and$$

$${k}_{5 , D} = \frac{{k}_{5 , 5} + {k}_{5 , 6}}{2} .$$

(4.7) Parameters of the spatial distribution function of the reactive ion flux in the region C and the region D are calculated by following formulas:

$${λ}_{1 , C} = - \frac{\sqrt{- 4 {k}_{1 , C} \cdot {k}_{3 , C} + {k}_{2 , C}^{2}} + {k}_{2 , C}}{2 {k}_{3 , C}} ,$$

$${λ}_{2 , C} = \frac{\sqrt{- 4 {k}_{1 , C} \cdot {k}_{3 , C} + {k}_{2 , C}^{2}} - {k}_{2 , C}}{2 {k}_{3 , C}} ;$$

$${λ}_{1 , D} = - \frac{\sqrt{- 4 {k}_{1 , D} \cdot {k}_{3 , D} + {k}_{2 , D}^{2}} + {k}_{2 , D}}{2 {k}_{3 , D}} ,$$

$${λ}_{2 , D} = \frac{\sqrt{- 4 {k}_{1 , D} \cdot {k}_{3 , D} + {k}_{2 , D}^{2}} - {k}_{2 , D}}{2 {k}_{3 , D}} ;$$

$${M}_{p} = [ \begin{matrix}{e}^{{λ}_{1 , D} {L}_{p}} & {e}^{{λ}_{2 , D} {L}_{p}} & 0 & 0 & 0 \\ 0 & 0 & {e}^{{λ}_{1 , C} {L}_{p} / 2} & {e}^{{λ}_{2 , C} {L}_{p} / 2} & 1 \\ {e}^{{λ}_{1 , D} {L}_{p} / 2} & {e}^{{λ}_{2 , D} {L}_{p} / 2} & 0 & 0 & 1 \\ {λ}_{1 , D} {e}^{{λ}_{1 , D} {L}_{p} / 2} & {λ}_{2 , D} {e}^{{λ}_{2 , D} {L}_{p} / 2} & - {λ}_{1 , C} {e}^{{λ}_{1 , C} {L}_{p} / 2} & - {λ}_{2 , C} {e}^{{λ}_{2 , C} {L}_{p} / 2} & 0 \\ {e}^{{λ}_{1 , D} {L}_{p} / 2} & {e}^{{λ}_{2 , D} {L}_{p} / 2} & 1 & 1 & 1\end{matrix} ] ;$$

$$and$$

$$[ \begin{matrix}{m}_{1 , D} \\ {m}_{2 , D} \\ {m}_{1 , C} \\ {m}_{2 , C} \\ {m}_{3 , C}\end{matrix} ] = {M}_{p}^{- 1} [ \begin{matrix}\frac{{k}_{4 , D}}{{k}_{1 , D}} \\ 0 \\ \frac{{k}_{4 , D}}{{k}_{1 , D}} - \frac{{k}_{4 , C}}{{k}_{1 , C}} \\ 0 \\ \frac{{k}_{4 , D}}{{k}_{1 , D}} - \frac{I}{{A}_{p} {Fa}_{s , p , av}}\end{matrix} ] .$$

If a condition number of a matrix Mₚ is too large in practical applications, a balance method can be used for inversion to reduce an error. The spatial distribution expressions of the reactive ion flux in the regions C and D are:

$${j}_{n , C} ( x ) = - {m}_{1 , C} {λ}_{1 , C} {e}^{{λ}_{1 , C} x} - {m}_{2 , C} {λ}_{2 , C} {e}^{{λ}_{2 , C} x} ; and$$

$${j}_{n , D} ( x ) = - {m}_{1 , D} {λ}_{1 , D} {e}^{{λ}_{1 , D} x} - {m}_{2 , D} {λ}_{2 , D} {e}^{{λ}_{2 , D} x} .$$

By substituting a coordinate of a point to be analyzed into a corresponding formula in the above two formulas, the reactive ion flux at the point to be analyzed can be obtained:

$${j}_{n , 4} = - {m}_{1 , C} {λ}_{1 , C} - {m}_{2 , C} {λ}_{2 , C} ;$$

$${j}_{n , 5} = - {m}_{1 , D} {λ}_{1 , D} {e}^{{λ}_{1 , D} {L}_{p} / 2} - {m}_{2 , D} {λ}_{2 , D} {e}^{{λ}_{2 , D} {L}_{p} / 2} ;$$

$$and$$

$${j}_{n , 6} = - {m}_{1 , D} {λ}_{1 , D} {e}^{{λ}_{1 , D} {L}_{p}} - {m}_{2 , D} {λ}_{2 , D} {e}^{{λ}_{2 , D} {L}_{p}} .$$

(5) A potential distribution function and a voltage drop of the electrolyte between the points to be analyzed in the negative electrode region are calculated; a potential distribution function and a voltage drop of the electrolyte between the points to be analyzed in the positive electrode region are calculated; a voltage drop of the electrolyte in a separator region is calculated; and a voltage drop of the electrolyte in the battery is calculated. A specific process thereof includes as follows.

(5.1) The potential distribution function of the electrolyte between the points to be analyzed in the negative electrode region is calculated, in which a region A is:

$${φ}_{e , A} = {k}_{5 , A} ( \frac{{m}_{1 , A}}{{λ}_{1 , A}} ( {e}^{{λ}_{1 , A} x} - 1 ) + \frac{{m}_{2 , A}}{{λ}_{2 , A}} ( {e}^{{λ}_{2 , A} x} - 1 ) - \frac{{k}_{4 , A}}{{k}_{1 , A}} x ) ;$$

and

a region B is:

$${φ}_{e , B} = {k}_{5 , A} ( {m}_{1 , A} ( {e}^{{λ}_{1 , A} {L}_{n} / 2} - 1 ) + {m}_{2 , A} ( {e}^{{λ}_{2 , A} {L}_{n} / 2} - 1 ) - \frac{{k}_{4 , A}}{{k}_{1 , A}} ) {L}_{n} / 2 + {k}_{5 , B} ( \frac{{m}_{1 , B}}{{λ}_{1 , B}} ( {e}^{{λ}_{1 , B} x} - {e}^{{λ}_{1 , B} {L}_{n} / 2} ) + \frac{{m}_{2 , B}}{{λ}_{2 , B}} ( {e}^{{λ}_{2 , B} x} - {e}^{{λ}_{2 , B} {L}_{n} / 2} - 1 ) + {m}_{3 , B} ( x - {L}_{n} / 2 ) ) .$$

Accordingly, the voltage drop of the electrolyte in the region A and the region B can be respectively obtained as:

$$d {φ}_{e , A} = {k}_{5 , A} ( \frac{{m}_{1 , A}}{{λ}_{1 , A}} ( {e}^{{λ}_{1 , A} {L}_{n} / 2} - 1 ) + \frac{{m}_{2 , A}}{{λ}_{2 , A}} ( {e}^{{λ}_{2 , A} {L}_{n} / 2} - 1 ) - \frac{{k}_{4 , A}}{{k}_{1 , A}} {L}_{n} / 2 ) ; and$$

$$d {φ}_{e , B} = {k}_{5 , A} ( {m}_{1 , A} ( {e}^{{λ}_{1 , A} {L}_{n} / 2} - 1 ) + {m}_{2 , A} ( {e}^{{λ}_{2 , A} {L}_{n} / 2} - 1 ) - \frac{{k}_{4 , A}}{{k}_{1 , A}} ) {L}_{n} / 2 + {k}_{5 , B} ( \frac{{m}_{1 , B}}{{λ}_{1 , B}} ( {e}^{{λ}_{1 , B} {L}_{n}} - {e}^{{λ}_{1 , B} {L}_{n} / 2} ) + \frac{{m}_{2 , B}}{{λ}_{2 , B}} ( {e}^{{λ}_{2 , B} {L}_{n}} - {e}^{{λ}_{2 , B} {L}_{n} / 2} ) + {m}_{3 , B} {L}_{n} / 2 ) .$$

(5.2) The potential distribution function of the electrolyte between the points to be analyzed in the negative electrode region is calculated, in which a region C is:

$${φ}_{e , C} = {k}_{5 , D} ( {m}_{1 , D} {e}^{{λ}_{1 , D} {L}_{p} / 2} + {m}_{2 , D} {e}^{{λ}_{2 , D} {L}_{p} / 2} - \frac{{k}_{4 , D}}{{k}_{1 , D}} ) {L}_{p} / 2 + {k}_{5 , C} ( \frac{{m}_{1 , C}}{{λ}_{1 , C}} ( {e}^{{λ}_{1 , {c}^{x}}} - 1 ) + \frac{{m}_{2 , C}}{{λ}_{2 , C}} ( {e}^{{λ}_{2 , {c}^{x}}} - 1 ) + {m}_{3 , C} x ) ; and$$

a region D is:

$${φ}_{e , D} = {k}_{5 , D} ( \frac{{m}_{1 , D}}{{λ}_{1 , D}} ( {e}^{{λ}_{1 , D} {L}_{p}} - {e}^{{λ}_{1 , D} x} ) + \frac{{m}_{2 , D}}{{λ}_{2 , D}} ( {e}^{{λ}_{2 , D} {L}_{p}} - {e}^{{λ}_{2 , D} x} ) - \frac{{k}_{4 , D}}{{k}_{1 , D}} ( {L}_{p} - x ) ) .$$

Accordingly, the voltage drop of the electrolyte in the region C and the region D can be respectively obtained as:

$$d {φ}_{e , C} = {k}_{5 , D} ( {m}_{1 , D} {e}^{{λ}_{1 , D} {L}_{p} / 2} + {m}_{2 , D} {e}^{{λ}_{2 , D} {L}_{p} / 2} - \frac{{k}_{4 , D}}{{k}_{1 , D}} ) {L}_{p} / 2 + {k}_{5 , C} ( \frac{{m}_{1 , C}}{{λ}_{1 , C}} ( {e}^{{λ}_{1 , C} {L}_{2} / 2} - 1 ) + \frac{{m}_{2 , C}}{{λ}_{2 , C}} ( {e}^{{λ}_{2 , C} {L}_{2} / 2} - 1 ) + {m}_{3 , C} {L}_{p} / 2 ; and$$

$$d {φ}_{e , D} = {k}_{5 , D} ( \frac{{m}_{1 , D}}{{λ}_{1 , D}} ( {e}^{{λ}_{1 , D} {L}_{p}} - {e}^{{λ}_{1 , D} {L}_{p} / 2} ) + \frac{{m}_{2 , D}}{{λ}_{2 , D}} ( {e}^{{λ}_{2 , D} {L}_{p}} - {e}^{{λ}_{2 , D} {L}_{p} / 2} ) - \frac{{k}_{4 , D}}{{k}_{1 , D}} {L}_{p} / 2 ) .$$

(5.3) The voltage drop of the electrolyte in the separator region is calculated:

$$d {φ}_{e , sep} = - \frac{{IL}_{sep}}{{A}_{sep} \frac{{κ}_{7} + {κ}_{8} + {κ}_{9}}{3}} .$$

(5.4) An overall voltage drop of the electrolyte in the battery is calculated by taking a potential at a point χ₁ to be analyzed as a zero potential reference point:

$$d {φ}_{e} = d {φ}_{e , A} + d {φ}_{e , B} + d {φ}_{e , C} + d {φ}_{e , D} + d {φ}_{e , sep} .$$

In this method, fast, accurate, and simple characteristics required for practical applications of a lithium-ion battery simulation technology are considered, and an approximate analytical expression of the spatial distribution function of the reactive ion flux inside the battery is obtained through a reasonable simplification of the electrochemical mechanism of the lithium-ion battery. An approximate spatial distribution of the potential of the electrolyte of the battery is further obtained, which implements an accurate estimation of the reaction state inside the battery, as well as greatly reduces a computational complexity. Using this method, the complexity of a traditional electrochemical model of the lithium-ion battery can be reduced, and its application in practical engineering can be promoted.

1. A method for estimating a reactive ion flux and a potential inside a lithium-ion battery, comprising following steps:
(1) obtaining a port current and a port temperature of the battery; obtaining an electrode parameter of the battery; setting coordinates of points to be analyzed inside the battery; obtaining a concentration of lithium ions in an electrolyte at the points to be analyzed inside the battery; obtaining a concentration of lithium ions on a surface of an electrode active material at the points to be analyzed inside the battery; obtaining a volume fraction of the electrode active material at the points to be analyzed inside the battery; obtaining lateral resistivity of a solid electrolyte film on the surface of the electrode active material at the points to be analyzed inside the battery; and obtaining a volume fraction of the electrolyte at the points to be analyzed inside the battery;
(2) calculating reaction rate constants of a positive electrode and a negative electrode of the battery; calculating a conductivity of the electrolyte at the points to be analyzed inside the battery; calculating a polarization coefficient of the electrolyte at the points to be analyzed inside the battery; and calculating a surface equilibrium potential on a surface of an active material at the points to be analyzed inside the battery;
(3) calculating a surface area to volume ratio of the electrode active material in a negative electrode region; calculating an average ion flux in the negative electrode region; calculating an exchange current density of a benchmark reaction at the points to be analyzed in the negative electrode region; calculating a first-order Taylor expansion at the average ion flux of a Butler-Volmer equation at the points to be analyzed in the negative electrode region; calculating an intermediate parameter of a spatial distribution expression of the reactive ion flux in the negative electrode region; calculating a parameter of the spatial distribution expression of the reactive ion flux in the negative electrode region; calculating a spatial distribution function of the reactive ion flux between the points to be analyzed in the negative electrode region; and calculating the reactive ion flux at the points to be analyzed in the negative electrode region;
(4) calculating a surface area to volume ratio of the electrode active material in a positive electrode region; calculating an average ion flux in the positive electrode region; calculating an exchange current density of a benchmark reaction at the points to be analyzed in the positive electrode region; calculating a first-order Taylor expansion at the average ion flux of a Butler-Volmer equation at the points to be analyzed in the positive electrode region; calculating an intermediate parameter of a spatial distribution expression of the reactive ion flux in the positive electrode region; calculating a parameter of the spatial distribution expression of the reactive ion flux in the positive electrode region; calculating a spatial distribution function of the reactive ion flux between the points to be analyzed in the positive electrode region; and calculating the reactive ion flux at the points to be analyzed in the positive electrode region; and
(5) calculating a potential distribution function and a voltage drop of the electrolyte between the points to be analyzed in the negative electrode region; calculating a potential distribution function and a voltage drop of the electrolyte between the points to be analyzed in the positive electrode region; calculating a voltage drop of the electrolyte in a separator region; and calculating a voltage drop of the electrolyte in the battery.

2. The method for estimating the reactive ion flux and the potential inside the lithium-ion battery according to claim 1, wherein step (1) comprises:
(1.1) obtaining the port current and the port temperature of the battery, denoted as I and T respectively;
(1.2) obtaining relevant electrode parameters of the battery according to information of a manufacturer queried based on a battery type or according to an electrochemical model of the lithium-ion battery, the relevant electrode parameters comprising: a thickness Lₙ of the negative electrode, a thickness Lₛₑₚ of the separator, and a thickness Lₚ of the positive electrode; a particle radius R_{s,n} of a negative electrode active material, and a particle radius R_{s,p} of a positive electrode active material; and an equivalent cross-sectional area Aₙ of the negative electrode, an equivalent cross-sectional area Aₚ of the positive electrode, and an equivalent cross-sectional area Aₛₑₚ of the separator;
(1.3) setting the coordinates of the points to be analyzed inside the battery, wherein three points are each selected in the negative electrode region and the positive electrode region as the points to be analyzed according to a characteristic of a chemical reaction inside the battery, and are respectively
a point of the negative electrode region close to a negative electrode plate with a coordinate x₁=0, a midpoint of the negative electrode region with a coordinate x₂=Lₙ/2, and a point of the negative electrode region close to the separator region with a coordinate x₃=Lₙ, and
a point of the positive electrode region close to the separator region with a coordinate x₄ Lₙ+Lₛₑₚ, a midpoint of the positive electrode region with a coordinate x₅=Lₙ+Lₛₑₚ+Lₚ/2, and a point of the positive electrode region close to a positive electrode plate with a coordinate x₆=Lₙ+Lₛₑₚ+Lₚ,
in addition, wherein three points are also selected in the separator region as the points to be analyzed, and are an interface between the separator region and the negative electrode region with a coordinate x₇=Lₙ, a midpoint of the separator region with a coordinate x₈=Lₙ+Lₛₑₚ/2, and an interface between the separator region and the positive electrode region with a coordinate x₉=Lₙ+Lₛₑₚ, respectively;
(1.4) obtaining a concentration of the lithium ions in the electrolyte at a point [x₁,x₂,x₃,x₄,x₅,x₆,x₇,x₈,x₉] according to the electrochemical model of the lithium-ion battery, denoted as [c_{e,1},c_{e,2},c_{e,3},c_{e,4},c_{e,5},c_{e,6},c_{e,7},c_{e,8},c_{e,9}];
(1.5) obtaining a concentration of the lithium ions on the surface of the electrode active material at a point [x₁,x₂,x₃,x₄,x₅,x₆] according to the electrochemical model of the lithium-ion battery, denoted as [c_{s,1},c_{s,2},c_{s,3},c_{s,4},c_{s,5},c_{s,6}];
(1.6) obtaining a volume fraction of the active material at the point [x₁, x₂,x₃, x₄,x₅,x₆] according to the information of the manufacturer or an aging model of the lithium-ion battery, denoted as [ε_{s,1},ε_{s,2},ε_{s,3},ε_{s,4},Σε_{s,5},ε_{s,6}];
(1.7) obtaining lateral resistivity of the solid electrolyte film on the surface of the active material at the point [x₁,x₂,x₃,x₄,x₅,x₆] according to the information of the manufacturer or the aging model of the lithium-ion battery, denoted as [R_{ƒ,1},R_{ƒ,2},R_{ƒ,3},R_{ƒ,4},R_{ƒ,5},R_{ƒ,6}]; and
(1.8) obtaining a volume fraction of the electrolyte at the point [x₁,x₂,x₃,x₄,x₅,x₆,x₇,x₈,x₉] according to the information of the manufacturer or the aging model of the lithium-ion battery, denoted as [ε_{e,1},ε_{e,2},ε_{e,3},ε_{e,4},ε_{e,5},ε_{e,6},ε_{e,7},ε_{e,8},ε_{e,9}].

3. The method for estimating the reactive ion flux and the potential inside the lithium-ion battery according to claim 1, wherein step (2) comprises:
(2.1) calculating the reaction rate constants of the positive electrode and the negative electrode denoted in a standard state according to a material property of the electrode and a temperature of the battery, wherein the reaction rate constant of the positive electrode is k_{r,p,ref}, the reaction rate constant of the negative electrode is k_{r,p,ref}, a reaction rate activation energy of the positive electrode is E_{r,p}, and a reaction rate activation energy of the negative electrode is E_{r,n}, then the reaction rate constants of the negative electrode and the positive electrode at a current temperature T are respectively:
$${k}_{r , n} = exp ( - {E}_{r , n} / R / T + {E}_{r , n} / R / {T}_{ref} + ln ( {k}_{r , n , ref} ) ) ; and$$
$${k}_{r , p} = exp ( - {E}_{r , p} / R / T + {E}_{r , p} / R / {T}_{ref} + ln ( {k}_{r , p , ref} ) ) ;$$
where an ideal gas constant R=8.314 J/mol/K;
(2.2) calculating the conductivity of the electrolyte at the points to be analyzed according to a material property of the electrolyte, wherein a relationship between the conductivity of the electrolyte and a lithium concentration in the electrolyte is denoted as: κ_{ref}=ƒ_{κ}(cₑ,T), then the conductivity of the electrolyte at each point to be analyzed is:
$${κ}_{i} = {f}_{κ} ( {c}_{e , i} , T ) \times {ε}_{e , i}^{p} , i = 1 , 2 , … , 9 ;$$
where p is a Bruggeman correction coefficient, p=1.5;
(2.3) calculating the polarization coefficient of the electrolyte at the points to be analyzed according to the material property of the electrolyte:
$${κ}_{D , i} = \frac{2 RT ( {t}_{0}^{+} - 1 )}{F} {κ}_{i} ( 1 + {f}_{κ D} ( {c}_{e , i} ) ) , i = 1 , 2 , … , 9 ;$$
where a Faraday constant F=96485 C/mol, an ion mobility number t₀⁺=0.38, and a polarization function ƒ_{κD}(cₑ) depends on the material of the electrolyte; and
(2.4) obtaining a type of active materials used in the positive and negative electrodes, and querying a functional relationship between a reaction equilibrium potential of the active materials, a lithium intercalation rate, and an electrode temperature, wherein the positive electrode is denoted as ƒ_{OCP,p}(x;T), and the negative electrode is denoted as ƒ_{OCP,n}(x;T),
calculating maximum lithium concentrations that the positive and negative electrode active materials can accommodate respectively: c_{s,p/n}^{max}=ρ_{p/n}/M_{p/n}, where ρ is a density of the active materials, and M is a relative molar mass of the active materials, and
calculating the surface equilibrium potentials on the surfaces of the active materials for three points to be analyzed in the negative electrode region and three points to be analyzed in the positive electrode region:
$${U}_{OCP , i} = {f}_{OCP , n} ( \frac{{c}_{s , i}}{{c}_{s , n}^{max}} ; T ) , i = 1 , 2 , 3 ;$$
$$and$$
$${U}_{OCP , i} = {f}_{OCP , p} ( \frac{{c}_{s , i}}{{c}_{s , p}^{max}} ; T ) , i = 4 , 5 , 6.$$

4. The method for estimating the reactive ion flux and the potential inside the lithium-ion battery according to claim 1, wherein step (3) comprises:
(3.1) calculating a surface area to volume ratio and a surface area to volume ratio average value of particles in the active material at the points to be analyzed in the negative electrode region:
$${a}_{s , i} = \frac{3 {ε}_{s , i}}{{R}_{s , n}} , i = 1 , 2 , 3 ;$$
$$and$$
$${a}_{s , n , av} = \frac{{a}_{s , 1} + {a}_{s , 2} + {a}_{s , 3}}{3} ;$$
(3.2) calculating the average ion flux in the negative electrode region:
$${j}_{n , n , av} = \frac{I}{{a}_{s , n , av} {A}_{n} {L}_{n} F} ;$$
(3.3) calculating the exchange current density of the benchmark reaction at the points to be analyzed in the negative electrode region:
$${i}_{0 , i} = {k}_{r , n} \sqrt{{c}_{e , i} {c}_{s , i} ( {c}_{s , n}^{m ax} - {c}_{s , i} )} , i = 1 , 2 , 3 ;$$
(3.4) calculating the first-order Taylor expansion at j_{n,n,av} of the Butler-Volmer equation at the points to be analyzed in the negative electrode region, and obtaining its slope a_{j,i} and intercept b_{j,i}:
$${a}_{j , i} = \frac{RT}{{i}_{0 , i}} \frac{\sqrt{\frac{{F}^{2} {j}_{n , n , av}^{2}}{4 {i}_{0 , i}^{2}} + 1} + \frac{{Fj}_{n , n , av}}{2 {i}_{0 , i}}}{\frac{{Fj}_{n , n , av}}{2 {i}_{0 , i}} \sqrt{\frac{{F}^{2} {j}_{n , n , av}^{2}}{4 {i}_{0 , i}^{2}} + 1} + \frac{{F}^{2} {j}_{n , n , av}^{2}}{4 {i}_{0 , i}^{2}} + 1} , i = 1 , 2 , 3 ; and$$
$${b}_{j , i} = - {j}_{n , n , av} {a}_{j , i} + \frac{2 RT}{F} ln ( \frac{{Fj}_{n , n , av}}{2 {i}_{0 , i}} + \sqrt{\frac{{F}^{2} {j}_{n , n , av}^{2}}{4 {i}_{0 , i}^{2}} + 1} ) , i = 1 , 2 , 3 ;$$
(3.5) calculating relevant variable gradients at the points to be analyzed in the negative electrode region, comprising a logarithmic function gradient of a lithium ion concentration in the electrolyte, a surface equilibrium potential gradient of the active material, a slope gradient and an intercept gradient in (3.4), and a lateral resistivity gradient of the solid electrolyte film, wherein;
at a point i=1, gradients are obtained by following formulas:
$${dce}_{1} = \frac{\partial ln ( {c}_{e} )}{\partial x} {\vert}_{x = {x}_{1}} = \frac{- 3 ln ( {c}_{e , 1} ) + 4 ln ( {c}_{e , 2} ) - ln ( {c}_{e , 3} )}{{x}_{3} - {x}_{1}} ;$$
$${docp}_{1} = \frac{\partial ( {U}_{OCP} )}{\partial x} {\vert}_{x = {x}_{1}} = \frac{- 3 {U}_{OCP , 1} + 4 {U}_{OCP , 2} - {U}_{OCP , 3}}{{x}_{3} - {x}_{1}} ;$$
$${daj}_{1} = \frac{\partial ( {a}_{j} )}{\partial x} {\vert}_{x = {x}_{1}} = \frac{- 3 {a}_{j , 1} + 4 {a}_{j , 2} - {a}_{j , 3}}{{x}_{3} - {x}_{1}} ;$$
$${dbj}_{1} = \frac{\partial ( {b}_{j} )}{\partial x} {\vert}_{x = {x}_{1}} = \frac{- 3 {b}_{j , 1} + 4 {b}_{j , 2} - {b}_{j , 3}}{{x}_{3} - {x}_{1}} ; and$$
$${dR}_{f , 1} = \frac{\partial ( {R}_{f} )}{\partial x} {\vert}_{x = {x}_{1}} = \frac{- 3 {R}_{f , 1} + 4 {R}_{f , 2} - {R}_{f , 3}}{{x}_{3} - {x}_{1}} ;$$
at a point i=2, gradients are obtained by following formulas:
$${dce}_{2} = \frac{\partial ln ( {c}_{e} )}{\partial x} {\vert}_{x = {x}_{2}} = \frac{ln ( {c}_{e , 3} ) - ln ( {c}_{e , 1} )}{{x}_{3} - {x}_{1}} ;$$
$${docp}_{2} = \frac{\partial ( {U}_{OCP} )}{\partial x} {\vert}_{x = {x}_{2}} = \frac{{U}_{OCP , 3} - {U}_{OCP , 1}}{{x}_{3} - {x}_{1}} ;$$
$${daj}_{2} = \frac{\partial ( {a}_{j} )}{\partial x} {\vert}_{x = {x}_{2}} = \frac{{a}_{j , 3} - {a}_{j , 1}}{{x}_{3} - {x}_{1}} ;$$
$${dbj}_{2} = \frac{\partial ( {b}_{j} )}{\partial x} {\vert}_{x = {x}_{2}} = \frac{{b}_{j , 3} - {b}_{j , 1}}{{x}_{3} - {x}_{1}} ; and$$
$${dR}_{f , 2} = \frac{\partial ( {R}_{f} )}{\partial x} {\vert}_{x = {x}_{2}} = \frac{{R}_{f , 3} - {R}_{f , 1}}{{x}_{3} - {x}_{1}} ;$$
and
at a point i=3, gradients are obtained by following formulas:
$${dce}_{3} = \frac{\partial ln ( {c}_{e} )}{\partial x} {\vert}_{x = {x}_{3}} = \frac{ln ( {c}_{e , 1} ) - 4 ln ( {c}_{e , 2} ) + 3 ln ( {c}_{e , 3} )}{{x}_{3} - {x}_{1}} ;$$
$${docp}_{3} = \frac{\partial ( {U}_{OCP} )}{\partial x} {\vert}_{x = {x}_{3}} = \frac{{U}_{OCP , 1} - 4 {U}_{OCP , 2} + 3 {U}_{OCP , 3}}{{x}_{3} - {x}_{1}} ;$$
$${dbj}_{3} = \frac{\partial ( {b}_{j} )}{\partial x} {\vert}_{x = {x}_{3}} = \frac{{b}_{j , 1} - 4 {b}_{j , 2} + 3 {b}_{j , 3}}{{x}_{3} - {x}_{1}} ;$$
$${dbj}_{3} = \frac{\partial ( {b}_{j} )}{\partial x} {\vert}_{x = {x}_{3}} = \frac{{b}_{j , 1} - 4 {b}_{j , 2} + 3 {b}_{j , 3}}{{x}_{3} - {x}_{1}} ; and$$
$${dR}_{f , 3} = \frac{\partial ( {R}_{f} )}{\partial x} {\vert}_{x = {x}_{3}} = \frac{{R}_{f , 1} - 4 {R}_{f , 2} + 3 {R}_{f , 3}}{{x}_{3} - {x}_{1}} ;$$
(3.6) calculating five intermediate parameters of the spatial distribution function of the reactive ion flux in the negative electrode region, first calculating the intermediate parameters at each point to be analyzed:
$${k}_{1 , i} = {Fa}_{s , i} ( \frac{1}{{σ}_{s , n}} + \frac{1}{{κ}_{i}} ) , i = 1 , 2 , 3 ;$$
$${k}_{2 , i} = F \cdot {dR}_{f , i} + {da}_{j , i} , i = 1 , 2 , 3 ;$$
$${k}_{3 , i} = F \cdot {R}_{f , i} + {a}_{j , i} , i = 1 , 2 , 3 ;$$
$${k}_{4 , i} = \frac{{κ}_{D , i}}{{κ}_{i}} \cdot {dce}_{i} - {docp}_{i} - {db}_{j , i} - \frac{I}{{A}_{n} {σ}_{s , n}} , i = 1 , 2 , 3 ; and$$
$${k}_{5 , i} = - \frac{{Fa}_{s , i}}{{κ}_{i}} , i = 1 , 2 , 3 ;$$
and
denoting a region between the points i=1 and i=2 to be analyzed as A, a region between the points i=2 and i=3 to be analyzed as B, and calculating intermediate parameters corresponding to the regions:
$${k}_{1 , A} = \frac{{k}_{1 , 1} + {k}_{1 , 2}}{2} ,$$
$${k}_{2 , A} = \frac{{k}_{2 , 1} + {k}_{2 , 2}}{2} ,$$
$${k}_{3 , A} = \frac{{k}_{3 , 1} + {k}_{3 , 2}}{2} ,$$
$${k}_{4 , A} = \frac{{k}_{4 , 1} + {k}_{4 , 2}}{2} ,$$
$${k}_{5 , A} = \frac{{k}_{5 , 1} + {k}_{5 , 2}}{2} ;$$
$${k}_{1 , B} = \frac{{k}_{1 , 2} + {k}_{1 , 3}}{2} ,$$
$${k}_{2 , B} = \frac{{k}_{2 , 2} + {k}_{2 , 3}}{2} ,$$
$${k}_{3 , B} = \frac{{k}_{3 , 2} + {k}_{3 , 3}}{2} ,$$
$${k}_{4 , A} = \frac{{k}_{4 , 2} + {k}_{4 , 3}}{2} , and$$
$${k}_{5 , B} = \frac{{k}_{5 , 2} + {k}_{5 , 3}}{2} ;$$
and
(3.7) calculating parameters of the spatial distribution function of the reactive ion flux in the region A and the region B by following formulas:
$${λ}_{1 , A} = - \frac{\sqrt{4 {k}_{1 , A} \cdot {k}_{3 , A} + {k}_{2 , A}^{2}} + {k}_{2 , A}}{2 {k}_{3 , A}} ,$$
$${λ}_{2 , A} = \frac{\sqrt{4 {k}_{1 , A} \cdot {k}_{3 , A} + {k}_{2 , A}^{2}} - {k}_{2 , A}}{2 {k}_{3 , A}} ;$$
$${λ}_{1 , B} = - \frac{\sqrt{4 {k}_{1 , B} \cdot {k}_{3 , B} + {k}_{2 , B}^{2}} + {k}_{2 , B}}{2 {k}_{3 , B}} ,$$
$${λ}_{2 , B} = \frac{\sqrt{4 {k}_{1 , B} \cdot {k}_{3 , B} + {k}_{2 , B}^{2}} - {k}_{2 , B}}{2 {k}_{3 , B}} ;$$
$${M}_{n} = [ \begin{matrix}1 & 1 & 0 & 0 & 0 \\ 0 & 0 & {e}^{{λ}_{1 , B} {L}_{n} / 2} & {e}^{{λ}_{2 , B} {L}_{n} / 2} & 1 \\ {e}^{{λ}_{1 , A} {L}_{n} / 2} & {e}^{{λ}_{2 , A} {L}_{n} / 2} & 0 & 0 & 1 \\ {λ}_{1 , A} {e}^{{λ}_{1 , A} {L}_{n} / 2} & {λ}_{2 , A} {e}^{{λ}_{2 , A} {L}_{n / 2}} & - {λ}_{1 , B} {e}^{{λ}_{1 , B} {L}_{n} / 2} & - {λ}_{2 , B} {e}^{{λ}_{2 , B} {L}_{n} / 2} & 0 \\ {e}^{{λ}_{1 , A} {L}_{n} / 2} & {e}^{{λ}_{2 , A} {L}_{n} / 2} & {e}^{{λ}_{1 , B} {L}_{n}} & {e}^{{λ}_{2 , B} {L}_{n}} & 1\end{matrix} ] ; and$$
$$[ \begin{matrix}{m}_{1 , A} \\ {m}_{2 , A} \\ {m}_{1 , B} \\ {m}_{2 , B} \\ {m}_{3 , B}\end{matrix} ] = {M}_{n}^{- 1} [ \begin{matrix}\frac{{k}_{4 , A}}{{k}_{1 , A}} \\ 0 \\ \frac{{k}_{4 , A}}{{k}_{1 , A}} - \frac{{k}_{4 , B}}{{k}_{1 , B}} \\ 0 \\ \frac{{k}_{4 , A}}{{k}_{1 , A}} + \frac{I}{{A}_{n} F {a}_{s , n , av}}\end{matrix} ] ;$$
wherein if a condition number of a matrix Mₙ is too large in practical applications, a balance method can be used for inversion to reduce an error, and the spatial distribution expressions of the reactive ion flux in the regions A and B are respectively:
$${j}_{n , A} ( x ) = {m}_{1 , A} {λ}_{1 , A} {e}^{{λ}_{1 , A} x} + {m}_{2 , A} {λ}_{2 , A} {e}^{{λ}_{2 , A} x} ; and$$
$${j}_{n , B} ( x ) = {m}_{1 , B} {λ}_{1 , B} {e}^{{λ}_{1 , B} x} + {m}_{2 , B} {λ}_{2 , B} {e}^{{λ}_{2 , B} x} ;$$
and
by substituting a coordinate of a point to be analyzed into a corresponding formula in the above two formulas, the reactive ion flux at the point to be analyzed can be obtained:
$${j}_{n , 1} = {m}_{1 , A} {λ}_{1 , A} + {m}_{2 , A} {λ}_{2 , A} ;$$
$${j}_{n , 2} = {m}_{1 , A} {λ}_{1 , A} {e}^{{λ}_{1 , A} {L}_{n} / 2} + {m}_{2 , A} {λ}_{2 , A} {e}^{{λ}_{2 , A} {L}_{n} / 2} ; and$$
$${j}_{n , 3} = {m}_{1 , B} {λ}_{1 , B} {e}^{{λ}_{1 , B} {L}_{n}} + {m}_{2 , B} {λ}_{2 , B} {e}^{{λ}_{2 , B} {L}_{n}} .$$

5. The method for estimating the reactive ion flux and the potential inside the lithium-ion battery according to claim 1, wherein step (4) comprises:
(4.1) calculating a surface area to volume ratio and a surface area to volume ratio average value of particles of an active material at the points to be analyzed in the positive electrode region:
$${a}_{s , i} = \frac{3 {ε}_{s , i}}{{R}_{s , p}} , i = 4 , 5 , 6 ; and$$
$${a}_{a , p , av} = \frac{{a}_{s , 4} + {a}_{s , 5} + {a}_{s , 6}}{3} ;$$
(4.2) calculating the average ion flux in the positive electrode region:
$${j}_{n , p , av} = - \frac{I}{{a}_{s , p , av} {A}_{p} {L}_{p} F} ;$$
(4.3) calculating the exchange current density of the benchmark reaction at the points to be analyzed in the positive electrode region:
$${i}_{0 , i} = {k}_{r , p} \sqrt{{c}_{e , i} {c}_{s , i} ( {c}_{s , p}^{ma x} - {c}_{s , i} )} , i = 4 , 5 , 6 ;$$
(4.4) calculating the first-order Taylor expansion of the Butler-Volmer equation at j_{n,p,av} at the points to be analyzed in the positive electrode region, and obtaining its slope a_{j,i} and intercept b_{j,i}:
$${a}_{j , i} = \frac{RT}{{i}_{0 , i}} \frac{\sqrt{\frac{{F}^{2} {j}_{n , p , av}^{2}}{4 {i}_{0 , i}^{2}} + 1} + \frac{{Fj}_{n , p , av}}{2 {i}_{0 , i}}}{\frac{{Fj}_{n , p , av}}{2 {i}_{0 , i}} \sqrt{\frac{{F}^{2} {j}_{n , p , av}^{2}}{4 {i}_{0 , i}^{2}} + 1} + \frac{{F}^{2} {j}_{n , p , av}^{2}}{4 {i}_{0 , i}^{2}} + 1} , i = 1 , 2 , 3 ; and$$
$${b}_{j , i} = - {j}_{n , p , av} {a}_{j , i} + \frac{2 RT}{F} ln ( \frac{{Fj}_{n , p , av}}{2 {i}_{0 , i}} + \sqrt{\frac{{F}^{2} {j}_{n , p , av}^{2}}{4 {i}_{0 , i}^{2}} + 1} ) , i = 1 , 2 , 3 ;$$
(4.5) calculating relevant variable gradients at the points to be analyzed in the positive electrode region, comprising a logarithmic function gradient of a lithium ion concentration in the electrolyte, a surface equilibrium potential gradient of the active material, a slope gradient and an intercept gradient in (4.4), and a lateral resistivity gradient of the solid electrolyte film, wherein;
at a point i=4, gradients are obtained by following formulas:
$${dce}_{4} = \frac{\partial ln ( {c}_{e} )}{\partial x} {\vert}_{x = {x}_{4}} = \frac{- 3 ln ( {c}_{e , 4} ) + 4 ln ( {c}_{e , 5} ) - ln ( {c}_{e , 6} )}{{x}_{6} - {x}_{4}} ;$$
$${docp}_{4} = \frac{\partial ( {U}_{OCP} )}{\partial x} {\vert}_{x = {x}_{4}} = \frac{- 3 {U}_{OCP , 4} + 4 {U}_{OCP , 5} - {U}_{OCP , 6}}{{x}_{6} - {x}_{4}} ;$$
$${daj}_{4} = \frac{\partial ( {a}_{j} )}{\partial x} {\vert}_{x = {x}_{4}} = \frac{- 3 {a}_{j , 4} + 4 {a}_{j , 5} - {a}_{j , 6}}{{x}_{6} - {x}_{4}} ;$$
$${dbj}_{4} = \frac{\partial ( {b}_{j} )}{\partial x} {\vert}_{x = {x}_{4}} = \frac{- 3 {b}_{j , 4} + 4 {b}_{j , 5} - {b}_{j , 6}}{{x}_{6} - {x}_{4}} ; and$$
$${dR}_{f , 4} = \frac{\partial ( {R}_{f} )}{\partial x} {\vert}_{x = {x}_{4}} = \frac{- 3 {R}_{f , 4} + 4 {R}_{f , 5} - {R}_{f , 6}}{{x}_{6} - {x}_{4}} ;$$
at a point i=5, gradients are obtained by following formulas:
$${{dce}_{5} = \frac{\partial ln ( {c}_{e} )}{\partial x} \vert}_{x = {x}_{5}} = \frac{ln ( {c}_{e , 6} ) - ln ( {c}_{e , 4} )}{{x}_{6} - {x}_{4}} ;$$
$${{docp}_{5} = \frac{\partial ( {U}_{OCP} )}{\partial x} \vert}_{x = {x}_{5}} = \frac{{U}_{OCP , 6} - {U}_{OCP , 4}}{{x}_{6} - {x}_{4}} ;$$
$${{daj}_{5} = \frac{\partial ( {a}_{j} )}{\partial x} \vert}_{x = {x}_{5}} = \frac{{a}_{j , 6} - {a}_{j , 4}}{{x}_{6} - {x}_{4}} ;$$
$${{dbj}_{5} = \frac{\partial ( {b}_{j} )}{\partial x} \vert}_{x = {x}_{5}} = \frac{{b}_{j , 6} - {b}_{j , 4}}{{x}_{6} - {x}_{4}} ;$$
$$and$$
$${{dR}_{f , 5} = \frac{\partial ( {R}_{f} )}{\partial x} \vert}_{x = {x}_{5}} = \frac{{R}_{f , 6} - {R}_{f , 4}}{{x}_{6} - {x}_{4}} ;$$
and
at a point i=6, gradients are obtained by following formulas:
$${{dce}_{6} = \frac{\partial ln ( {c}_{e} )}{\partial x} \vert}_{x = {x}_{6}} = \frac{ln ( {c}_{e , 4} ) - 4 ln ( {c}_{e , 5} ) + 3 ln ( {c}_{e , 6} )}{{x}_{6} - {x}_{4}} ;$$
$${{docp}_{6} = \frac{\partial ( {U}_{OCP} )}{\partial x} \vert}_{x = {x}_{6}} = \frac{{U}_{OCP , 4} - 4 {U}_{OCP , 5} + 3 {U}_{OCP , 6}}{{x}_{6} - {x}_{4}} ;$$
$${{dbj}_{6} = \frac{\partial ( {b}_{j} )}{\partial x} \vert}_{x = {x}_{6}} = \frac{{b}_{j , 4} - 4 {b}_{j , 5} + 3 {b}_{j , 6}}{{x}_{6} - {x}_{4}} ;$$
$${{dbj}_{6} = \frac{\partial ( {b}_{j} )}{\partial x} \vert}_{x = {x}_{6}} = \frac{{b}_{j , 4} - 4 {b}_{j , 5} + 3 {b}_{j , 6}}{{x}_{6} - {x}_{4}} ;$$
$$and$$
$${{dR}_{f , 6} = \frac{\partial ( {R}_{f} )}{\partial x} \vert}_{x = {x}_{6}} = \frac{{R}_{f , 4} - 4 {R}_{f , 5} + 3 {R}_{f , 6}}{{x}_{6} - {x}_{4}} ;$$
(4.6) calculating five intermediate parameters of the spatial distribution function of the reactive ion flux in the positive electrode region, first calculating the intermediate parameters at each point to be analyzed:
$${k}_{1 , i} = {Fa}_{s , i} ( \frac{1}{{σ}_{s , p}} + \frac{1}{{κ}_{i}} ) , i = 4 , 5 , 6 ;$$
$${k}_{2 , i} = F \cdot {dR}_{f , i} + {da}_{j , i} , i = 4 , 5 , 6 ;$$
$${k}_{3 , i} = F \cdot {R}_{f , i} + {a}_{j , i} , i = 4 , 5 , 6 ;$$
$${k}_{4 , i} = \frac{{κ}_{D , i}}{{κ}_{i}} \cdot {dce}_{i} - {docp}_{i} - {db}_{j , i} - \frac{I}{{A}_{p} {σ}_{s , p}} , i = 4 , 5 , 6 ;$$
$$and$$
$${k}_{5 , i} = \frac{{Fa}_{s , i}}{{κ}_{i}} , i = 4 , 5 , 6 ;$$
denoting a region between the points i=4 and i=5 to be analyzed as C, a region between the points i=5 and i=6 to be analyzed as D, and calculating intermediate parameters corresponding to the regions:
$${k}_{1 , C} = \frac{{k}_{1 , 4} + {k}_{1 , 5}}{2} ,$$
$${k}_{2 , C} = \frac{{k}_{2 , 4} + {k}_{2 , 5}}{2} ,$$
$${k}_{3 , C} = \frac{{k}_{3 , 4} + {k}_{3 , 5}}{2} ,$$
$${k}_{4 , C} = \frac{{k}_{4 , 4} + {k}_{4 , 5}}{2} ,$$
$${k}_{5 , C} = \frac{{k}_{5 , 4} + {k}_{5 , 5}}{2} ;$$
$${k}_{1 , D} = \frac{{k}_{1 , 5} + {k}_{1 , 6}}{2} ,$$
$${k}_{2 , D} = \frac{{k}_{2 , 5} + {k}_{2 , 6}}{2} ,$$
$${k}_{3 , D} = \frac{{k}_{3 , 5} + {k}_{3 , 6}}{2} ,$$
$${k}_{4 , D} = \frac{{k}_{4 , 5} + {k}_{4 , 6}}{2} ,$$
$$and$$
$${k}_{5 , D} = \frac{{k}_{5 , 5} + {k}_{5 , 6}}{2} ;$$
and
(4.7) calculating parameters of the spatial distribution function of the reactive ion flux in the region C and the region D by following formulas:
$${λ}_{1 , C} = - \frac{\sqrt{- 4 {k}_{1 , C} \cdot {k}_{3 , C} + {k}_{2 , C}^{2}} + {k}_{2 , C}}{2 {k}_{3 , C}} ,$$
$${λ}_{2 , C} = \frac{\sqrt{- 4 {k}_{1 , C} \cdot {k}_{3 , C} + {k}_{2 , C}^{2}} - {k}_{2 , C}}{2 {k}_{3 , C}} ;$$
$${λ}_{1 , D} = - \frac{\sqrt{- 4 {k}_{1 , D} \cdot {k}_{3 , D} + {k}_{2 , D}^{2}} + {k}_{2 , D}}{2 {k}_{3 , D}} ,$$
$${λ}_{2 , D} = \frac{\sqrt{- 4 {k}_{1 , D} \cdot {k}_{3 , D} + {k}_{2 , D}^{2}} + {k}_{2 , D}}{2 {k}_{3 , D}} ;$$
$${M}_{p} = [ \begin{matrix}{e}^{{λ}_{1 , D} {L}_{p}} & {e}^{{λ}_{2 , D} {L}_{p}} & 0 & 0 & 0 \\ 0 & 0 & {e}^{{λ}_{1 , C} {L}_{p} / 2} & {e}^{{λ}_{2 , C} {L}_{p} / 2} & 1 \\ {e}^{{λ}_{1 , D} {L}_{p} / 2} & {e}^{{λ}_{2 , D} {L}_{p} / 2} & 0 & 0 & 1 \\ {λ}_{1 , D} {e}^{{λ}_{1 , D} {L}_{p} / 2} & {λ}_{2 , D} {e}^{{λ}_{2 , D} {L}_{p} / 2} & - {λ}_{1 , C} {e}^{{λ}_{1 , C} {L}_{p} / 2} & - {λ}_{2 , C} {e}^{{λ}_{2 , C} {L}_{p} / 2} & 0 \\ {e}^{{λ}_{1 , D} {L}_{p} / 2} & {e}^{{λ}_{2 , D} {L}_{p} / 2} & 1 & 1 & 1\end{matrix} ] ;$$
$$and$$
$$[ \begin{matrix}{m}_{1 , D} \\ {m}_{2 , D} \\ {m}_{1 , C} \\ {m}_{2 , C} \\ {m}_{3 , C}\end{matrix} ] = {M}_{p}^{- 1} [ \begin{matrix}\frac{{k}_{4 , D}}{{k}_{1 , D}} \\ 0 \\ \frac{{k}_{4 , D}}{{k}_{1 , D}} - \frac{{k}_{4 , C}}{{k}_{1 , C}} \\ 0 \\ \frac{{k}_{4 , D}}{{k}_{1 , D}} - \frac{I}{{A}_{p} {Fa}_{s , p , a υ}}\end{matrix} ] ;$$
wherein if a condition number of a matrix Mₚ is too large in practical applications, a balance method can be used for inversion to reduce an error, and the spatial distribution expressions of the reactive ion flux in the regions C and D are:
$${j}_{n , C} ( x ) = - {m}_{1 , C} {λ}_{1 , C} {e}^{{λ}_{1 , C} x} - {m}_{2 , C} {λ}_{2 , C} {e}^{{λ}_{2 , C} x} ;$$
$$and$$
$${j}_{n , D} ( x ) = - {m}_{1 , D} {λ}_{1 , D} {e}^{{λ}_{1 , D} x} - {m}_{2 , D} {λ}_{2 , D} {e}^{{λ}_{2 , D} x} ;$$
and
by substituting a coordinate of a point to be analyzed into a corresponding formula in the above two formulas, the reactive ion flux at the point to be analyzed can be obtained:
$${j}_{n , 4} = - {m}_{1 , C} {λ}_{1 , C} - {m}_{2 , C} {λ}_{2 , C} ;$$
$${j}_{n , 5} = - {m}_{1 , D} {λ}_{1 , D} {e}^{{λ}_{1 , D} {L}_{p} / 2} - {m}_{2 , D} {λ}_{2 , D} {e}^{{λ}_{2 , D} {L}_{p} / 2} ;$$
$$and$$
$${j}_{n , 6} = - {m}_{1 , D} {λ}_{1 , D} {e}^{{λ}_{1 , D} {L}_{p}} - {m}_{2 , D} {λ}_{2 , D} {e}^{{λ}_{2 , D} {L}_{p}} .$$

6. The method for estimating the reactive ion flux and the potential inside the lithium-ion battery according to claim 1, wherein step (5) comprises:
(5.1) calculating the potential distribution function of the electrolyte between the points to be analyzed in the negative electrode region, wherein a region A is:
$${φ}_{e , A} = {k}_{5 , A} ( \frac{{m}_{1 , A}}{{λ}_{1 , A}} ( {e}^{{λ}_{1 , A} x} - 1 ) + \frac{{m}_{2 , A}}{{λ}_{2 , A}} ( {e}^{{λ}_{2 , A} x} - 1 ) - \frac{{k}_{4 , A}}{{k}_{1 , A}} x ) ;$$
and
a region B is:
$${φ}_{e , B} = {k}_{5 , A} ( {m}_{1 , A} ( {e}^{{λ}_{1 , A} {L}_{n} / 2} - 1 ) + {m}_{2 , A} ( {e}^{{λ}_{2 , A} {L}_{n} / 2} - 1 ) - \frac{{k}_{4 , A}}{{k}_{1 , A}} ) {L}_{n} / 2 + {k}_{5 , B} ( \frac{{m}_{1 , B}}{{λ}_{1 , B}} ( {e}^{{λ}_{1 , B} x} - {e}^{{λ}_{1 , B} {L}_{n} / 2} ) + \frac{{m}_{2 , B}}{{λ}_{2 , B}} ( {e}^{{λ}_{2 , B} x} - {e}^{{λ}_{2 , B} {L}_{n} / 2} ) + {m}_{3 , B} ( x - {L}_{n} / 2 ) ) ;$$
accordingly, the voltage drop of the electrolyte in the region A and the region B can be respectively obtained as:
$$d {φ}_{e , A} = {k}_{5 , A} ( \frac{{m}_{1 , A}}{{λ}_{1 , A}} ( {e}^{{λ}_{1 , A} {L}_{n} / 2} - 1 ) + \frac{{m}_{2 , A}}{{λ}_{2 , A}} ( {e}^{{λ}_{2 , A} {L}_{n} / 2} - 1 ) - \frac{{k}_{4 , A}}{{k}_{1 , A}} ) {L}_{n} / 2 ) ;$$
$$and$$
$$d {φ}_{e , B} = {k}_{5 , A} ( {m}_{1 , A} ( {e}^{{λ}_{1 , A} {L}_{n} / 2} - 1 ) + {m}_{2 , A} ( {e}^{{λ}_{2 , A} {L}_{n} / 2} - 1 ) - \frac{{k}_{4 , A}}{{k}_{1 , A}} ) {L}_{n} / 2 + {k}_{5 , B} ( \frac{{m}_{1 , B}}{{λ}_{1 , B}} ( {e}^{{λ}_{1 , B} {L}_{n}} - {e}^{{λ}_{1 , B} {L}_{n} / 2} ) + \frac{{m}_{2 , B}}{{λ}_{2 , B}} ( {e}^{{λ}_{2 , B} {L}_{n}} - {e}^{{λ}_{2 , B} {L}_{n} / 2} ) + {m}_{3 , B} {L}_{n} / 2 ) ;$$
(5.2) calculating the potential distribution function of the electrolyte between the points to be analyzed in the negative electrode region, wherein a region C is:
$${φ}_{e , C} = {k}_{5 , D} ( {m}_{1 , D} {e}^{{λ}_{1 , D} {L}_{p} / 2} + {m}_{2 , D} {e}^{{λ}_{2 , D} {L}_{p} / 2} - \frac{{k}_{4 , D}}{{k}_{1 , D}} ) {L}_{p} / 2 + {k}_{5 , C} ( \frac{{m}_{1 , C}}{{λ}_{1 , C}} ( {e}^{{λ}_{1 , C} x} - 1 ) + \frac{{m}_{2 , C}}{{λ}_{2 , C}} ( {e}^{{λ}_{2 , C} x} - 1 ) + {m}_{3 , C} x ) ;$$
and
a region D is:
$${φ}_{e , D} = {k}_{5 , D} ( \frac{{m}_{1 , D}}{{λ}_{1 , D}} ( {e}^{{λ}_{1 , D} {L}_{p}} - {e}^{{λ}_{1 , D} x} ) + \frac{{m}_{2 , D}}{{λ}_{2 , D}} ( {e}^{{λ}_{2 , D} {L}_{p}} - {e}^{{λ}_{2 , D} x} ) - \frac{{k}_{4 , D}}{{k}_{1 , D}} ) {L}_{p} - x ) ) ;$$
accordingly, the voltage drop of the electrolyte in the region C and the region D can be respectively obtained as:
$$d {φ}_{e , C} = {k}_{5 , D} ( {m}_{1 , D} {e}^{{λ}_{1 , D} {L}_{p} / 2} + {m}_{2 , D} {e}^{{λ}_{2 , D} {L}_{p} / 2} - \frac{{k}_{4 , D}}{{k}_{1 , D}} ) {L}_{p} / 2 + {k}_{5 , C} ( \frac{{m}_{1 , C}}{{λ}_{1 , C}} ( {e}^{{λ}_{1 , C} {L}_{p} / 2} - 1 ) + \frac{{m}_{2 , C}}{{λ}_{2 , C}} ( {e}^{{λ}_{2 , C} {L}_{p} / 2} - 1 ) + {m}_{3 , C} {L}_{p} / 2 ) ;$$
$$and$$
$$d {φ}_{e , D} = {k}_{5 , D} ( \frac{{m}_{1 , D}}{{λ}_{1 , D}} ( {e}^{{λ}_{1 , D} {L}_{p}} - {e}^{{λ}_{1 , D} {L}_{p} / 2} ) + \frac{{m}_{2 , D}}{{λ}_{2 , D}} ( {e}^{{λ}_{2 , D} {L}_{p}} - {e}^{{λ}_{2 , D} {L}_{p} / 2} ) - \frac{{k}_{4 , D}}{{k}_{1 , D}} {L}_{p} / 2 ) ;$$
(5.3) calculating the voltage drop of the electrolyte in the separator region:
$$d {φ}_{e , sep} = - \frac{{IL}_{sep}}{{A}_{sep} \frac{{κ}_{7} + {κ}_{8} + {κ}_{9}}{3}} ;$$
and
(5.4) calculating an overall voltage drop of the electrolyte in the battery by taking a potential at a point χ₁ to be analyzed as a zero potential reference point:
$$d {φ}_{e} = d {φ}_{e , A} + d {φ}_{e , B} + d {φ}_{e , C} + d {φ}_{e , D} + d {φ}_{e , sep} .$$
